(19) United States
(12) Patent Application Publication
(10) Pub. No.: US 2025/0166240 A1
(43) Pub. Date: May 22, 2025

(54) ELECTRONIC DEVICE AND METHOD FOR GENERATING VIDEO WITH VERTIGO EFFECT

(71) Applicant: SAMSUNG ELECTRONICS CO., LTD., Suwon-si (KR)

(72) Inventors: .Kishan, Bangalore (IN); Ankit, Bangalore (IN); Dhamodaran Vemula, Bangalore (IN); Anshuman Srivastava, Bangalore (IN)

(73) Assignee: SAMSUNG ELECTRONICS CO., LTD., Suwon-si (KR)

(21) Appl. No.: 18/949,174

(22) Filed: Nov. 15, 2024

(30) Foreign Application Priority Data
Nov. 16, 2023 (IN) 202341077984

(51) Int. Cl. G06T 11/00; G06T 7/55; G06V 10/77; G06V 20/40

(52) U.S. Cl. CPC G06T 11/00; G06T 7/55; G06V 10/7715; G06V 20/46

(57) ABSTRACT

A method for generating a video with vertigo effect is provided. The method includes: obtaining a first image of a subject via a first camera; identifying an object corresponding to the subject from the first image; obtaining a plurality of second images of the subject with varying zoom levels via a second camera; identifying a plurality of backgrounds from the plurality of second images; determining a zoom level range based on the object and the plurality of backgrounds; and generating a video comprising the object and the plurality of backgrounds with zoom levels varying within the zoom level range.

### CROSS-REFERENCE TO RELATED APPLICATION

This application is based on and claims priority under 35 U.S.C. § 119 (a) to Indian patent application Ser. No. 20/234,1077984, filed on Nov. 16, 2023, in the Indian Patent Office, the disclosure of which is incorporated by reference herein in its entirety.

### BACKGROUND

### 1. Field

The disclosure relates to image processing, and more particularly, to a system, an electronic device, and a method for generating a video with vertigo effect.

### 2. Description of Related Art

The vertigo effect is a videography technique in which a main subject in a frame of a video remains the same size and in focus, while the remaining area of the frame is either zoomed in or out with respect to the main subject. The vertigo effect is a technique that has been used in filmmaking for over 100 years. For example, the vertigo effect is used by filmmakers to create an illusion of depth. Also, with the growing popularity of smartphones, users also have started using more cinematographic effects, including the vertigo effect, in smartphones.

In the related art, there are multiple methods for recording a video with the vertigo effect. For example, the most commonly used method of recording the video with the vertigo effect is a manual zooming method. In the manual zooming method, the user is required to move the camera away from or toward the main subject while manually zooming in or zooming out, such that the main subject remains the same size in the frame. The physical movement of the camera and manually changing the zoom level requires multiple attempts to capture a stable video with a decent vertigo effect. Also, the manual zooming method uses interpolation techniques for scaling the subject and reconstructing the background. Further, the physical movement of the camera along with manually zooming out or zooming in to create the vertigo effect may lead to abrupt zoom levels causing unrealistic generated output.

### SUMMARY

Provided are a system, an electronic device, and a method for generating a video with vertigo effect.

According to an aspect of the disclosure, a method includes: obtaining a first image of a subject via a first camera; identifying an object corresponding to the subject from the first image; obtaining a plurality of second images of the subject with varying zoom levels via a second camera; identifying a plurality of backgrounds from the plurality of second images; determining a zoom level range based on the object and the plurality of backgrounds; and generating a video comprising the object and the plurality of backgrounds with zoom levels varying within the zoom level range.

According to an aspect of the disclosure, a non-transitory computer readable medium includes instructions, when executed by one or more processors of an electronic device, that cause the electronic device to perform a method including: obtaining a first image of a subject via a first camera; identifying an object corresponding to the subject from the first image; obtaining a plurality of second images of the subject with varying zoom levels via a second camera; identifying a plurality of backgrounds from the plurality of second images; determining a zoom level range based on the object and the plurality of backgrounds; and generating a video comprising the object and the plurality of backgrounds with zoom levels varying within the zoom level range.

According to an aspect of the disclosure, an electronic device includes: memory storing instructions; and one or more processors comprising processing circuitry, wherein the instructions, when executed by the one or more processors individually or collectively, cause the electronic device to: obtain a first image of a subject via a first camera; identify an object corresponding to the subject from the first image; obtain a plurality of second images of the subject with varying zoom levels via a second camera; identify a plurality of backgrounds from the plurality of second images; determine a zoom level range based on the object and the plurality of backgrounds; and generate a video comprising the object, and the plurality of backgrounds with zoom levels varying within the zoom level range.

To further clarify the advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

The above and other features, aspects, and advantages of certain embodiments of the present disclosure will become better understood when the following detailed description is read with reference to the accompanying drawings, in which:

FIG. 1 is a block diagram of an electronic device comprising a system for generating a video with vertigo effect, according to an embodiment of the present disclosure;

FIG. 2 is a block diagram of a plurality of modules of the system for generating the video with the vertigo effect, according to an embodiment of the present disclosure;

FIG. 3 are views depicting use-case scenarios for determining a set of optimum imaging parameters, according to an embodiment of the present disclosure;

FIG. 4 is a block diagram depicting a training process of a reinforcement learning-based Artificial Intelligence (AI) model, according to an embodiment of the present disclosure;

FIGS. 5A and 5B are diagrams illustrating identification of one or more secondary cameras from a set of secondary cameras required to capture at least one second image, according to an embodiment of the present disclosure;

FIG. 6 is a diagram illustrating segmentation of at least one first image and the at least one second image into a set of objects, in accordance with an embodiment of the present disclosure;

FIG. 7 is a diagram illustrating selection of one or more object maps from a set of object maps, in accordance with an embodiment of the present disclosure;

FIG. 8 is a diagram illustrating segmentation of at least one first image and the at least one second image into one or more backgrounds, in accordance with an embodiment of the present disclosure;

FIGS. 9A and 9B are diagrams illustrating use-case scenarios for determining a range of zoom levels for generating the vertigo effect, in accordance with an embodiment of the present disclosure;

FIGS. 10A, 10B, 10C, and 10D are diagrams illustrating determination of the range of zoom levels for generating the vertigo effect, in accordance with an embodiment of the present disclosure;

FIG. 11A is a block diagram depicting a process of generating the vertigo effect, in accordance with an embodiment of the present disclosure;

FIG. 11B is a block diagram depicting a process of generating the vertigo effect, in accordance with an embodiment of the present disclosure;

FIG. 11C is a diagram illustrating a process of obtaining a set of merged frames, in accordance with an embodiment of the present disclosure;

FIG. 11D is a diagram illustrating use-case scenarios for selection of a frame for a corresponding zoom value, in accordance with an embodiment of the present disclosure;

FIG. 11E is a diagram illustrating obtaining the set of merged frames in a zooming-in scenario, in accordance with an embodiment of the present disclosure;

FIG. 11F is a diagram illustrating obtaining the set of merged frames in a zooming-out scenario, in accordance with an embodiment of the present disclosure;

FIG. 11G is a diagram illustrating sequential merging of frames, in accordance with an embodiment of the present disclosure;

FIG. 11H is a diagram illustrating sequential merging of frames at different resolutions, in accordance with an embodiment of the present disclosure;

FIGS. 12A and 12B are block diagrams depicting an operation of the system for generating the video with vertigo effect, according to an embodiment of the present disclosure; and

FIG. 13 is a flow diagram illustrating a method for generating the video with vertigo effect, in accordance with an embodiment of the present disclosure.

### DETAILED DESCRIPTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein. Throughout the drawings, like reference numerals will be understood to refer to like parts, components, and structures.

It is to be understood that the singular forms “a,” “an,” and “the” include plural referents unless the context clearly dictates otherwise. Thus, for example, reference to “a component surface” includes reference to one or more of such surfaces.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

It should be understood that the terms “comprising,” “including,” and “having” are inclusive and therefore specify the presence of stated features, numbers, steps, operations, components, units, or their combination, but do not preclude the presence or addition of one or more other features, numbers, steps, operations, components, units, or their combination. In particular, numerals are to be understood as examples for the sake of clarity, and are not to be construed as limiting the embodiments by the numbers set forth.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

In order to create a video with a vertigo effect in methods of the related art, a user may be required to move toward or away from the main subject to cover a larger background. However, an optimal distance to cover the background region effectively is unknown to the user. Hence, multiple iterations may be required to generate the video with the vertigo effect. Even with multiple iterations, the vertigo effect may be accompanied by a shaky effect due to the user's trembling hand. Furthermore, the user is required to maintain a constant speed during the zoom-in and zoom-out operation to create the vertigo effect, because a sudden change in the speed may result in jittery zooming.

Further, in methods of the related art, the user may be required to move the camera to capture a larger Field of View (FoV) while increasing the zoom range. However, it may be difficult for the user to determine a correct zoom level and an appropriate speed of the physical camera movement needed to achieve desired vertigo effect for a corresponding scene, often leading to abruptness in a transition rather than a smooth transition in the recorded video. Hence, it may be a big challenge for the users to record the video with the vertigo effect. Furthermore, a single camera with limited digital zoom range and no optical zooming capability, may lead to degradation in the quality of the vertigo effect in the video.

Furthermore, in the methods of the related art, multiple variations of the vertigo effect for a particular moment (such as changing the direction of the zooming) as the required data was/is not captured in that instance to generate the vertigo effect. Moreover, the methods of the related art do not have the flexibility to provide users with an option to select different or multiple subjects as main subjects after capturing the video. Thus, in the methods of the related art, the vertigo effect is generated for a pre-decided subject with a pre-decided direction. Moreover, there is less flexibility to produce the vertigo effect if the main object starts moving along or into the scene. Further, the user is required to decide optimum capture parameters according to the given lighting conditions making the task of creating the vertigo effect more complicated.

In another conventional method, the video is automatically zoomed-in or zoomed-out, unidirectionally. Also, such methods of the related art also reconstruct the background of the video from the adjacent frames or neighboring pixels. Further, such methods of the related art detect the subject by moving the camera from a left direction to a right direction and start recording when the subject is in a Region of Interest (RoI). However, such methods of the related art fail to generate multiple vertigo effects using a single capture. Also, the background may have a degraded quality due to missing details. An example of missing details would be a case where the camera is required to move left or right. Accordingly, when the camera is at left position, the content of right direction is not recorded by the camera. As a result, the missing details in this case are the content of the right direction. Thus, the camera fails to create a good effect for moving background. Moreover, offline generation of the vertigo effect is usually not possible in such methods of the related art.

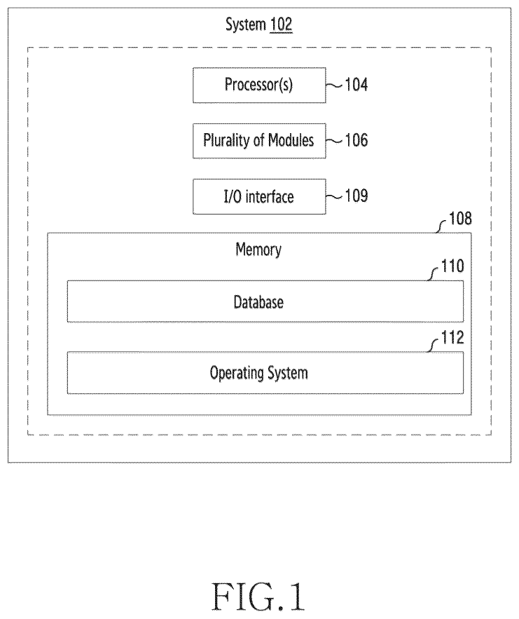

FIG. 1 illustrates a block diagram of an electronic device 100 comprising a system 102 for generating a video with a vertigo effect, according to an embodiment of the present disclosure. In an embodiment of the present disclosure, the system 102 may be hosted on the electronic device 100. In an example embodiment of the present disclosure, the electronic device 100 may be a smartphone, a camera, a laptop computer, a desktop computer, a wearable device, and any other device capable of processing the video to generate the vertigo effect. The electronic device 100 may include one or more processors 104, a plurality of modules 106, memory 108, and an Input/Output (I/O) interface 109.

In an example embodiment, the one or more processors 104 may be operatively coupled to each of the plurality of modules 106, the memory 108, and the I/O interface 109. In one embodiment, the one or more processors 104 may include at least one data processor for executing processes in Virtual Storage Area Network (VSAN). The one or more processors 104 may include specialized processing units such as integrated system (bus) controllers, memory management control units, floating point units, graphics processing units, digital signal processing units, etc. In one embodiment, the one or more processors 104 may include a central processing unit (CPU), a graphics processing unit (GPU), or both. The one or more processors 104 may be one or more general processors, digital signal processors, application-specific integrated circuits, field-programmable gate arrays, servers, networks, digital circuits, analog circuits, combinations thereof, or other now-known or later developed devices for analyzing and processing data. The one or more processors 104 may execute a software program, such as code generated manually (i.e., programmed) to perform the desired operation. In an embodiment of the present disclosure, the one or more processors 104 may be a general purpose processor, such as the CPU, an application processor (AP), or the like, a graphics-only processing unit such as the GPU, a visual processing unit (VPU), and/or an Artificial Intelligence (AI)-dedicated processor such as a neural processing unit (NPU). In an embodiment of the present disclosure, the one or more processors 104 execute data, and instructions stored in the memory 108 to generate the video with the vertigo effect.

The one or more processors 104 may be disposed in communication with one or more input/output (I/O) devices via the respective I/O interface 109. The I/O interface 109 may employ communication code-division multiple access (CDMA), high-speed packet access (HSPA+), global system for mobile communications (GSM), long-term evolution (LTE), WiMax, or the like, etc.

Using the I/O interface 109, the system 102 may communicate with one or more I/O devices, specifically, the user devices associated with the human-to-human conversation. For example, the input device may be an antenna, microphone, touch screen, touchpad, storage device, transceiver, video device/source, etc. The output devices may be a printer, fax machine, video display (e.g., cathode ray tube (CRT), liquid crystal display (LCD), light-emitting diode (LED), plasma, Plasma Display Panel (PDP), Organic light-emitting diode display (OLED) or the like), audio speaker, etc. In an embodiment of the present disclosure, the I/O interface 109 may be used to receive one or more inputs from the user for selecting at least one segmented object from segmented set of objects present in at least one first image and at least one second image. Further, the I/O interface 109 may display the video with the vertigo effect on a user interface screen of the electronic device 100. The details on the at least one segmented object, the segmented set of objects, the at least one first image, and the at least one second image have been elaborated in subsequent paragraphs.

The one or more processors 104 may be disposed in communication with a communication network via a network interface. In an embodiment, the network interface may be the I/O interface 109. The network interface may connect to the communication network to enable connection of the system 102 with the outside environment. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, and the like.

In some embodiments, the memory 108 may be communicatively coupled to the one or more processors 104. The memory 108 may be configured to store the data, and the instructions executable by the one or more processors 104 for generating the video with vertigo effect. In an embodiment of the present disclosure, the memory 108 may store the data, such as the first image, the second image, the set of objects, one or more backgrounds, a range of zoom level, the video with the vertigo effect, a set of predefined imaging parameters and the like. Details on the one or more backgrounds and the set of predefined imaging parameters have been elaborated in subsequent paragraphs. Further, the memory 108 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 108 may include a cache or random-access memory for the one or more processors 104. In alternative examples, the memory 108 is separate from the one or more processors 104, such as a cache memory of a processor, the system memory, or other memory. The memory 108 may be an external storage device or database for storing data. The memory 108 may be operable to store instructions executable by the one or more processors 104. The functions, acts, or tasks illustrated in the figures or described may be performed by the programmed processor/controller for executing the instructions stored in the memory 108. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

In some embodiments, the plurality of modules 106 may be included within the memory 108. The memory 108 may further include a database 110 to store the data for generating the video with the vertigo effect. The plurality of modules 106 may include a set of instructions that may be executed to cause the system 102 to perform any one or more of the methods/processes disclosed herein. The plurality of modules 106 may be configured to perform the steps of the present disclosure using the data stored in the database 110 for generating the video with the vertigo effect, as discussed herein. In an embodiment, the plurality of modules 106 may be embodied as a part of a program or software running on the electronic device 100, but is not limited thereto. For example, plurality of modules 106 may be a hardware unit that may be outside the memory 108, or embodied as a combination of a hardware unit and a software unit. Further, the memory 108 may include an operating system 112 for performing one or more tasks of the electronic device 100, as performed by a generic operating system 112 in the communications domain. In one embodiment, the database 110 may be configured to store the information as required by the plurality of modules 106 and the one or more processors 104 generating the video with vertigo effect. The term “-unit”, “-module”, etc. may refer to a unit in which at least one function or operation is processed and may be embodied as hardware, software, or a combination of hardware and software.

Further, the present disclosure also contemplates a computer-readable medium that includes instructions or receives and executes instructions responsive to a propagated signal. Further, the instructions may be transmitted or received over the network via a communication port or interface or using a bus. The communication port or interface may be a part of the one or more processors 104 or may be a separate component. The communication port may be created in software or may be a physical connection in hardware. The communication port may be configured to connect with a network, external media, the display, or any other components in the electronic device 100, or combinations thereof. The connection with the network may be a physical connection, such as a wired Ethernet connection, or may be established wirelessly. Likewise, the additional connections with other components of the electronic device 100 may be physical or may be established wirelessly. The network may alternatively be directly connected to the bus. For the sake of brevity, the architecture and standard operations of the operating system 112, the memory 108, the database 110, and the one or more processors 104 are not discussed in detail.

In an embodiment of the present disclosure, the electronic device 100 may include a camera. For example, the electronic device 100 may include two or more cameras. The electronic device 100 may include a primary camera and one or more secondary cameras, but is not limited thereto. The electronic device 100 may include a first camera and a second camera. The first camera may be the primary camera and the second camera may be a secondary camera, but is not limited thereto. For example, the first camera and the second camera may be embodied as a single camera in the electronic device 100. An image captured by the first camera (or the primary camera) may be referred to as a first image, and an image captured by the second camera (or the secondary camera) may be referred to as a second image. The electronic device 100 may have a single camera performing operations of the first camera and the second camera of the disclosure. In an embodiment of the present disclosure, the primary camera and the one or more secondary cameras may be separate from the electronic device 100, and the electronic device 100 may obtain at least one first image captured by the primary camera and at least one second image captured by the one or more secondary cameras via a wireless medium or a wired medium.

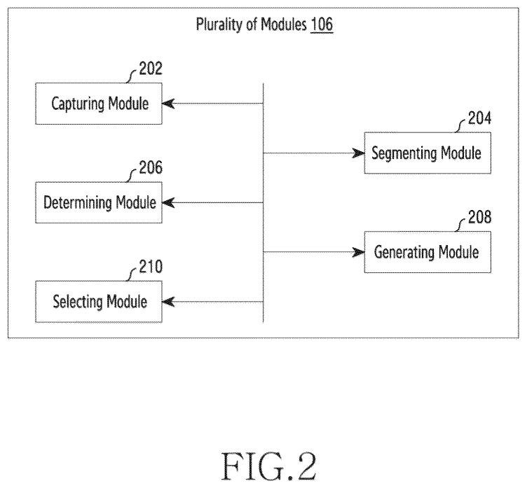

FIG. 2 illustrates a block diagram of a plurality of modules 106 of the system 102 for generating the video with the vertigo effect, according to an embodiment of the present disclosure. The illustrated embodiment of FIG. 2 also depicts a sequence flow of process among the plurality of modules 106 for generating the video with the vertigo effect. In an embodiment of the present disclosure, the plurality of modules 106 may include, but not limited to, a capturing module 202, a segmenting module 204, a determining module 206, a generating module 208, and a selecting module 210. The plurality of modules 106 may be implemented by way of suitable hardware and/or software applications. For the sake of clarity, operations of the modules 106 have been separated in the explanation, however, the operations described here may either be performed by any module or a single module.

The capturing module 202 may be configured to capture, via the primary camera having a first Field of View (FoV), the at least one first image. The at least one first image may be captured by using a set of predefined imaging parameters. In an embodiment of the present disclosure, each of the at least one first image may be associated with the first FoV. Further, each of the at least one first image may have varying zoom levels. For example, the at least one first image may have different zoom levels. For example, each of the at least one first image may have an incrementally different zoom level, but is not limited thereto. Each of the at least one first image may have a decrementally different zoom level. In an example embodiment of the present disclosure, the set of predefined imaging parameters may include an Exposure Value (EV), an International Organization for Standardization (ISO) value, a shutter speed, an aperture for a scene, or any combination thereof.

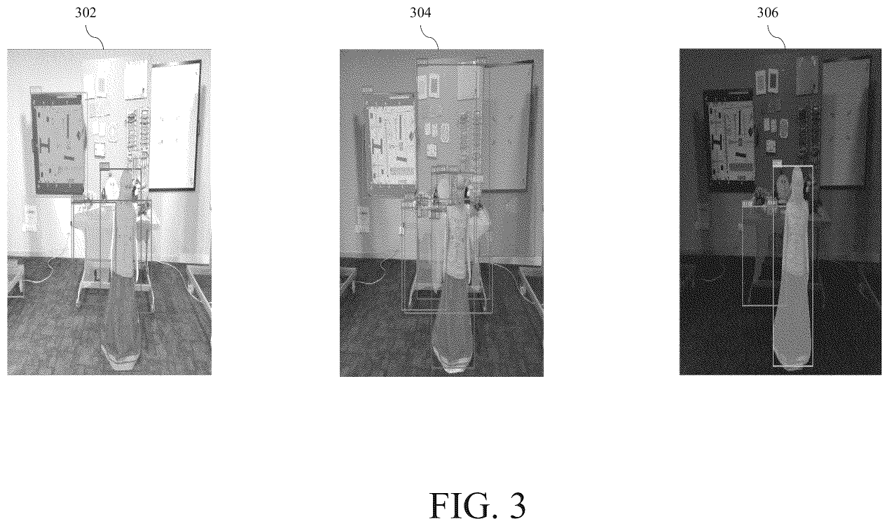

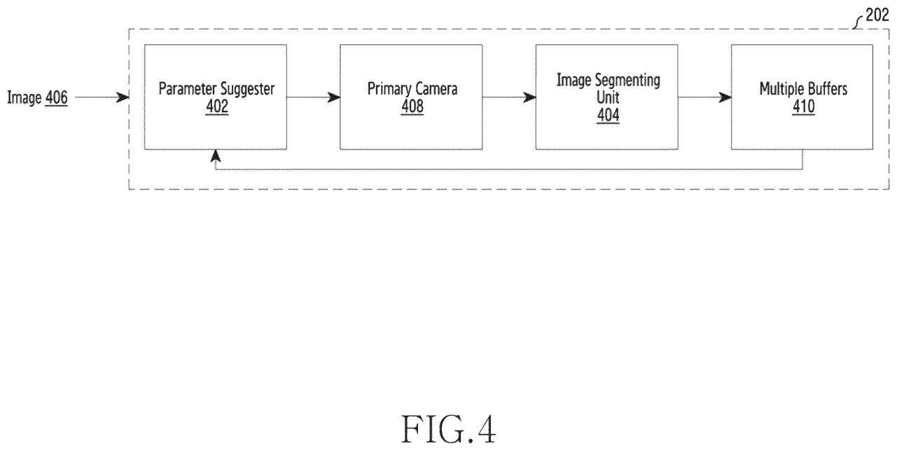

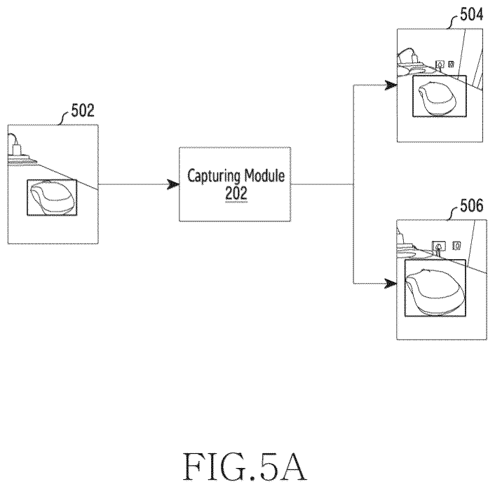

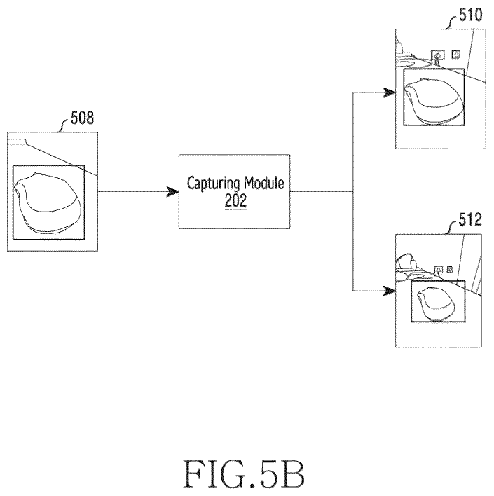

Further, the capturing module 202 may be configured to capture, via the one or more secondary cameras having a second FoV, the at least one second image. In an embodiment of the present disclosure, each of the at least one second image may be associated with the second FoV. Further, the at least one second image may have varying zoom levels. For example, the at least one second image may have different zoom levels. For example, each of the at least one second image may have an incrementally different zoom level, but is not limited thereto. Each of the at least one second image may have a decrementally different zoom level. In capturing the at least one second image, the capturing module 202 may be configured to determine, by analyzing a scene of the captured at least one first image, a set of imaging parameters using a reinforcement learning-based AI model. The determined imaging parameters may be used to capture the at least one second image. The details on the training of the reinforcement learning-based AI model have been elaborated in subsequent paragraphs at least with reference to FIG. 4. In an embodiment of the present disclosure, the set of imaging parameters may be similar to the set of predefined imaging parameters i.e., the EV, the ISO value, the shutter speed, the aperture for the scene, or any combination thereof. In an embodiment of the present disclosure, determination of the set of imaging parameters enables the detection of a maximum number of objects present in the at least one first image. The details on the determination of the set of imaging parameters have been elaborated in subsequent paragraphs at least with reference to FIG. 3. Further, the capturing module 202 may be configured to identify, by using the first FoV, the one or more secondary cameras from a set of secondary cameras required to capture the at least one second image upon determining the set of imaging parameters. Furthermore, the capturing module 202 may be configured to capture, via the identified one or more secondary cameras, the at least one second image by using the determined set of imaging parameters. The details on the identification of the one or more secondary cameras from the set of secondary cameras required to capture the at least one second image have been elaborated in subsequent paragraphs at least with reference to FIGS. 5A and 5B.

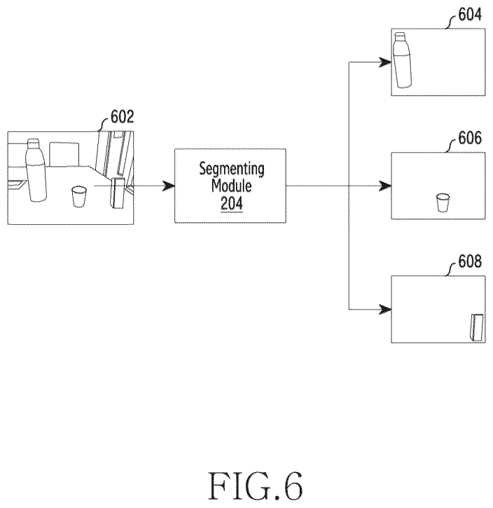

Furthermore, the segmenting module 204 may be configured to segment the captured at least one first image and the captured at least one second image into a set of objects and one or more backgrounds to identify an object and the backgrounds from the captured at least one first image and the captured at least one second image. The set of objects may be segmented from the captured at least one first image, and the one or more backgrounds may be segmented from the captured at least one second image. In an embodiment of the present disclosure, each of the one or more backgrounds may include a background image associated with the captured at least one first image and the captured at least one second image. According to an embodiment, an object map may be generated by performing the image segmentation on the at least one first image. In segmenting the captured at least one first image and the captured at least one second image into the set of objects, the segmenting module 204 may be configured to identify each pixel of the captured at least one first image. Further, the segmenting module 204 may be configured to classify each identified pixel into a pixel group of a plurality of pixel groups based on one or more pixel characteristics of each identified pixel. In an embodiment of the present disclosure, pixels in a corresponding pixel group of the plurality of pixel groups may be similar with respect to the one or more pixel characteristics. In an example embodiment of the present disclosure, the one or more pixel characteristics may include color, intensity, texture, or any combination thereof. The segmenting module 204 may be configured to obtain a set of object maps corresponding to each of the plurality of pixel groups based on the result of classification. In an embodiment of the present disclosure, the obtained set of object maps indicates the set of objects in the captured at least one first image. For example, the object indicated by the object map may be identified from the at least one first image. The details on the segmentation of the captured at least one first image and the captured at least one second image into the set of objects have been elaborated in subsequent paragraphs at least with reference to FIG. 6.

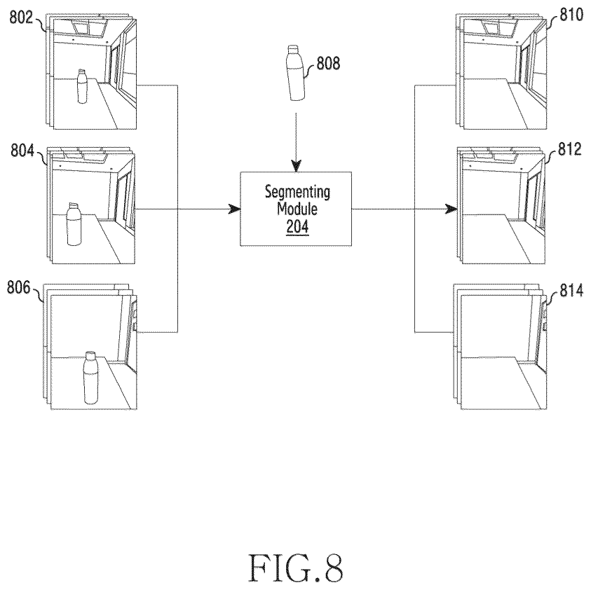

In segmenting the captured at least one first image and the captured at least one second image into the one or more backgrounds, the segmenting module 204 may be configured to obtain the at least one first image and the at least one second image having varying zoom levels before performing the image segmentation. In an embodiment of the present disclosure, the at least one first image and the at least one second image may be at different zoom levels, such that the selected at least one segmented object in the at least one first image and the at least one second image at different zoom levels may be not at the same zoom level. Further, the segmenting module 204 may be configured to adjust a zoom level of the selected at least one segmented object to a zoom level of each of the obtained at least one first image and the obtained at least one second image. For example, the selected at least one segmented object may be scaled up or down to the zoom level associated with a corresponding image for locating the selected at least one segmented object in the at least one first image and the at least one second image. The segmenting module 204 may be configured to detect, upon adjusting the zoom level, the selected at least one segmented object in each of the obtained at least one first image and the obtained at least one second image. Furthermore, the segmenting module 204 may be configured to erase pixels associated with the selected at least one segmented object from each of the obtained at least one first image and the obtained at least one second image. The segmenting module 204 may be configured to reconstruct, upon erasing pixels, empty pixels associated with selected at least one segmented object by using an image in-painting technique. Further, the segmenting module 204 may be configured to obtain, upon reconstructing the empty pixels, the one or more backgrounds associated with the obtained at least one first image and the obtained at least one second image. In an embodiment of the present disclosure, the one or more backgrounds are of different FoVs and zoom levels. The details on the segmentation of the captured at least one first image and the captured at least one second image into the one or more backgrounds have been elaborated in subsequent paragraphs at least with reference to FIG. 8.

In an embodiment of the present disclosure, a plurality of objects (or objects maps) may be identified from the first image, and then an object (or an object map) may be identified by selecting the object from the plurality of objects. For example, the selecting module 210 may be configured to receive an input from a user to select one or more object maps from the obtained set of object maps. Further, the selecting module 210 may be configured to select, based on the received input, the one or more object maps from the obtained set of object maps for generating the vertigo effect with respect to the selected one or more object maps.

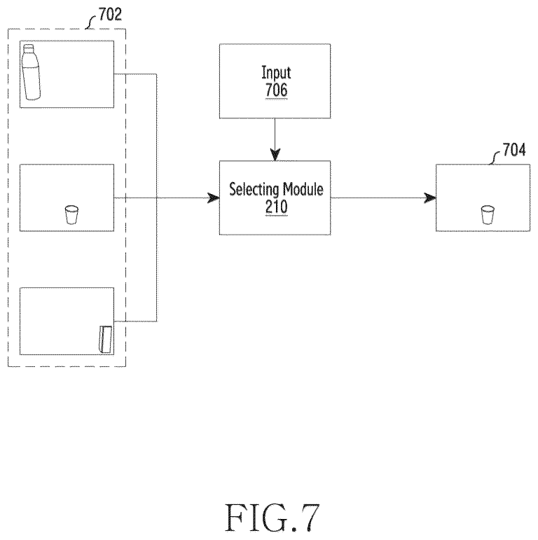

In an embodiment of the present disclosure, the selecting module 210 may be configured to automatically select, based on a position of the obtained set of object maps, the one or more object maps from the obtained set of object maps. In such embodiment, the one or more object maps may be automatically selected for generating the vertigo effect with respect to the automatically selected one or more object maps. Details on the selection of the one or more object maps from the set of object maps have been elaborated in subsequent paragraphs at least with reference to FIG. 7.

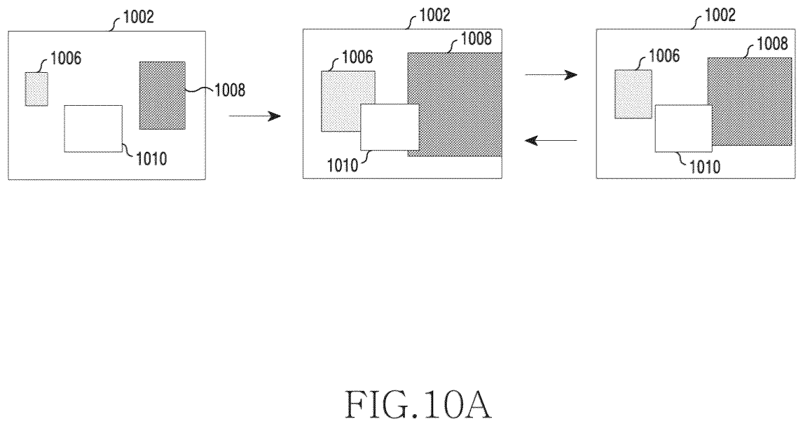

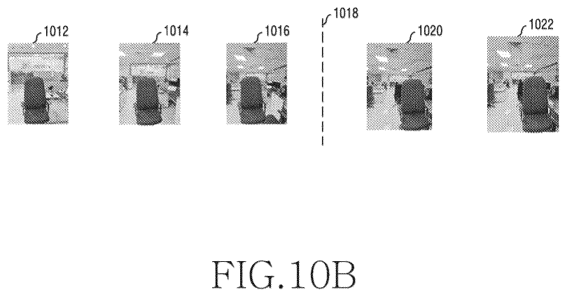

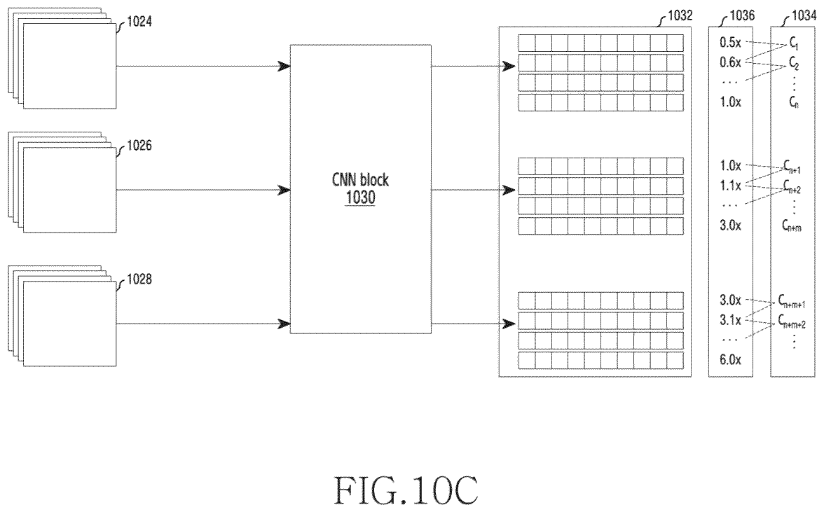

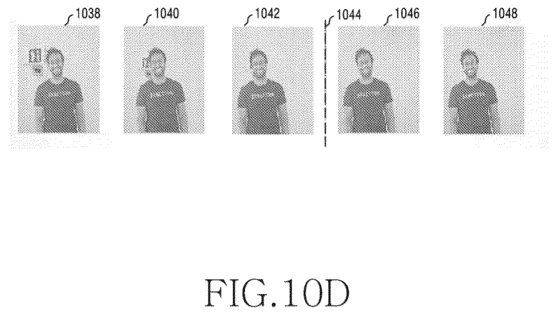

Thereafter, the determining module 206 may be configured to determine a range of zoom levels (or a zoom level range) for the vertigo effect based on the first FoV, the second FoV, a selected at least one segmented object, one or more segmented objects other than the selected at least one segmented object, the segmented one or more backgrounds, or any combination thereof. For example, the zoom level range may be determined based on the selected object and the one or more backgrounds. In an example embodiment of the present disclosure, the determining module 206 may use an AI module for analyzing the first FoV, the second FoV, the selected at least one segmented object, one or more segmented objects other than the selected at least one segmented object, the segmented one or more backgrounds, or any combination thereof to suggest the zoom level range for each of the one or more backgrounds. In an embodiment of the present disclosure, the at least one segmented object may be selected from the segmented set of objects. In an embodiment of the present disclosure, the range of zoom levels may correspond to a minimum zoom level and a maximum zoom level for the vertigo effect. In determining the range of zoom levels, the determining module 206 may be configured to determine the range of zoom levels for the vertigo effect based on the one or more backgrounds, zoom levels of the one or more backgrounds, the selected at least one segmented object, the one or more segmented objects other than the selected at least one segmented object from the segmented set of objects, one or more zooming parameters, or any combination thereof. In an example embodiment of the present disclosure, the one or more zooming parameters may include a size ratio between the selected at least one segmented object and the one or more segmented objects other than the selected at least one segmented object from the segmented set of objects, but is not limited thereto. For example, when there are secondary object maps in the background, while zooming in the background, objects indicated by the secondary object maps in the background may exceed a threshold value of a maximum frame occupancy and the objects indicated by the secondary object maps may look unrealistic. Hence, the final zoom levels of the image which has increased till the size ratio of the objects reaching the threshold value are selected by the determining module 206 as the maximum zoom level. Further, the one or more zooming parameters may also include a similarity index between backgrounds of the at least one first image and the at least one second image with varying zoom levels. In an embodiment of the present disclosure, the similarity index quantifies the similarity or dissimilarity between the backgrounds of the at least one first image and the at least one second image with varying zoom levels. For example, while zooming in or out, if the consecutive frames have very similar features (i.e., while zooming in or out, the background does not change or changes within a tolerance range of consistency) then the determining module 206 may suggest such zoom level where the background stops changing or changes within the tolerance range of consistency. In an example, when there are secondary object maps in the background and the background is zoomed out, objects indicated by the secondary object maps in the background may go below a threshold value of minimum frame occupancy and seem unrealistic or small. As a result, the final zoom level of the image which has decreased till the size of ratio of the objects reaching the threshold may be selected by the determining module 206 as the minimum zoom level. Details on the determination of the range of zoom levels have been elaborated in subsequent paragraphs at least with reference to FIGS. 7, 10A, 10B, 10C, and 10D.

In an embodiment of the present disclosure, the determining module 206 may consider one or more conditions while determining the range of zoom levels for the vertigo effect. For example, the one or more conditions may include whether the zoom level going beyond the range of camera capability, and the zooming may be restricted to the range of camera capability.

Further, the generating module 208 may be configured to generate the video with the vertigo effect by using the segmented one or more backgrounds, the determined range of zoom levels, and the selected at least one segmented object. For example, the video including selected object and the backgrounds with zoom levels varying within the determined zoom level range. In generating the video with the vertigo effect, the generating module 208 may be configured to receive one or more inputs from a user to select a user desired frame rate and/or a user desired duration for the vertigo effect. Further, the generating module 208 may be configured to determine if the user desired frame rate is lower than or greater than a current frame rate of the video. The generating module 208 may be configured to interpolate frames associated with the one or more backgrounds and the select at least one segmented object based on the user desired frame rate and the determined range of zoom levels. For example, for same speed with a different duration selected by the user, the video may be clipped to shorten the length of the video. In an embodiment of the present disclosure, the interpolation is performed upon determining that the user desired frame rate is greater than the current frame rate of the video.

Furthermore, the generating module 208 may be configured to obtain at least one intermediary frame associated with the one or more backgrounds and the at least one segmented object based on a result of interpolation. Further, the generating module 208 may be configured to obtain a set of merged frames by merging the frames associated with the one or more backgrounds and the selected object map, and the obtained at least one intermediary frame. The generating module 208 may be configured to generate the video with the vertigo effect by performing a fusion operation. In an embodiment of the present disclosure, the fusion operation may correspond to a fusion of the obtained set of merged frames associated with the video based on a type of vertigo effect. Further, the obtained set of merged frames may be fused at boundary zoom levels of the primary camera and the one or more secondary cameras. In an embodiment of the present disclosure, the type of vertigo effect may be a zooming-in vertigo effect or a zooming-out vertigo effect. In an embodiment of the present disclosure, the user may obtain a certain speed of the vertigo effect which will be directly proportional to Frames Per Second (FPS) with which the frames associated with the video are captured. For example, the total vertigo effect generated is of a speed 1× (60 FPS). If the user reduces the vertigo effect speed to 0.5× (120 fps), then one frame is interpolated between consecutive frames equally for the entire video duration. Further, the range of zoom levels may remain the same. Furthermore, when the user increases the vertigo effect speed to 2.0× (30 fps), then alternate frames may be dropped all over the video duration to reach the required fps, and the range of zoom levels may remain the same.

For generating the video based on the type of vertigo effect, the generating module 208 may be configured to generate the video with the vertigo effect by fusing the obtained set of merged frames at the boundary zoom levels of the primary camera and the one or more secondary cameras. In an embodiment of the present disclosure, the set of merged frames may be fused at the boundary zoom levels of the primary camera and the one or more secondary cameras based on an increasing zoom level in case of the zooming-in vertigo effect. Further, the set of merged frames are fused at the boundary zoom levels of the primary camera and the one or more secondary cameras based on a decreasing zoom level in case of the zooming-out vertigo effect. A level of FoV may be increased or decreased in the video with the vertigo effect.

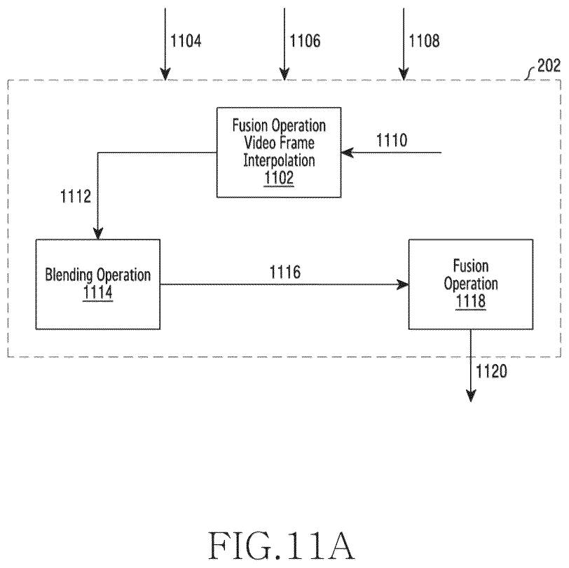

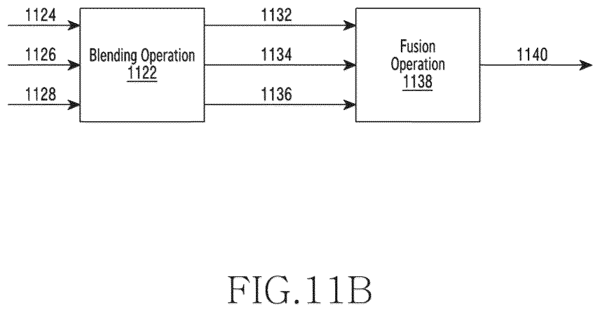

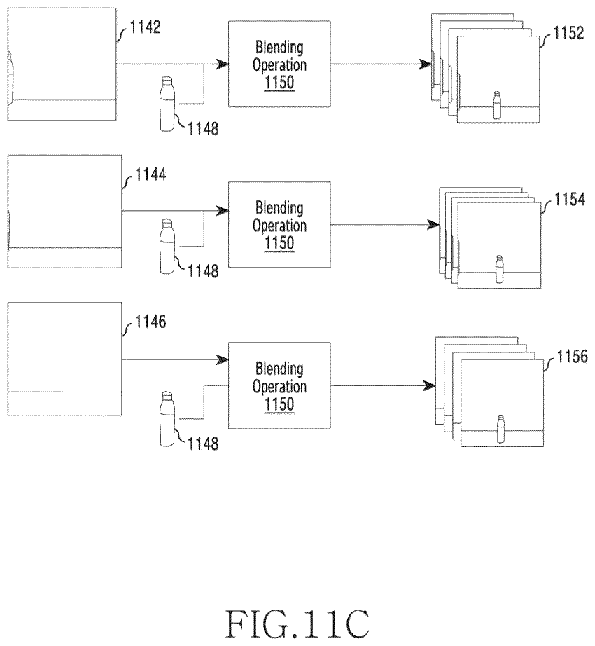

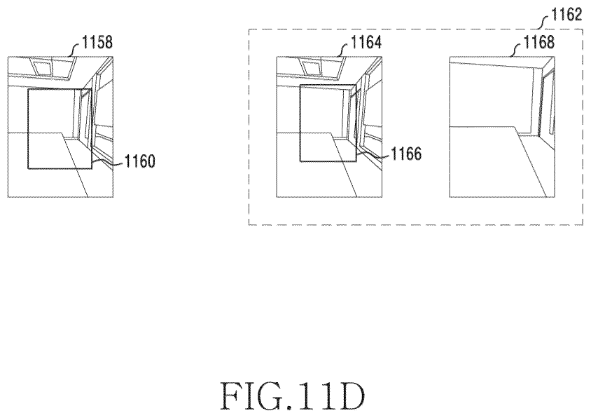

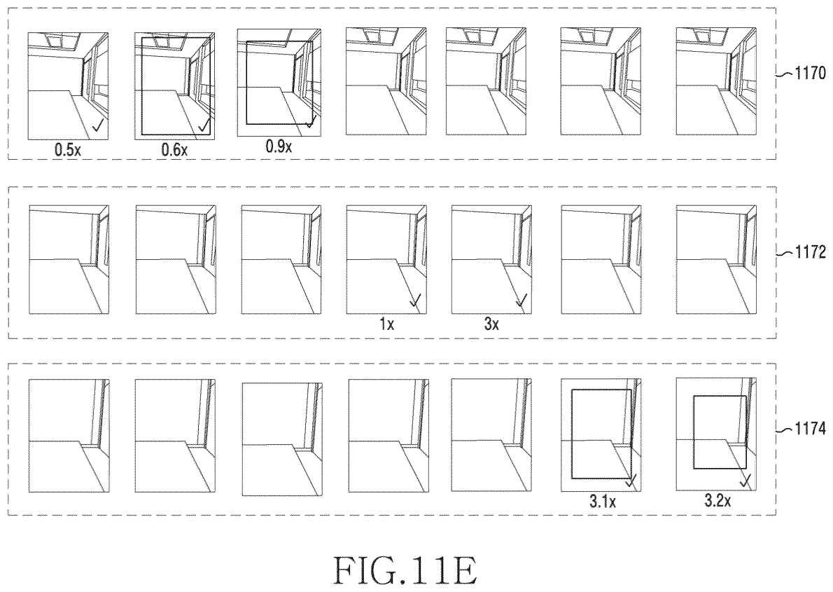

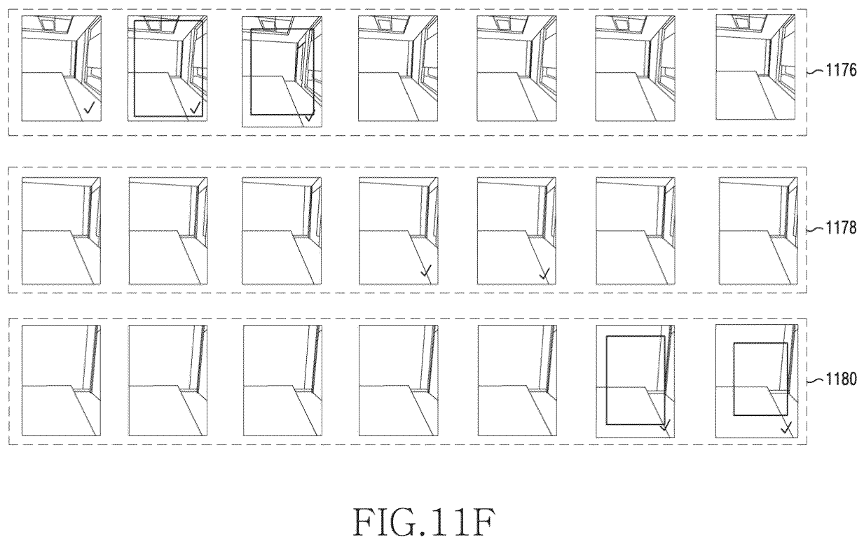

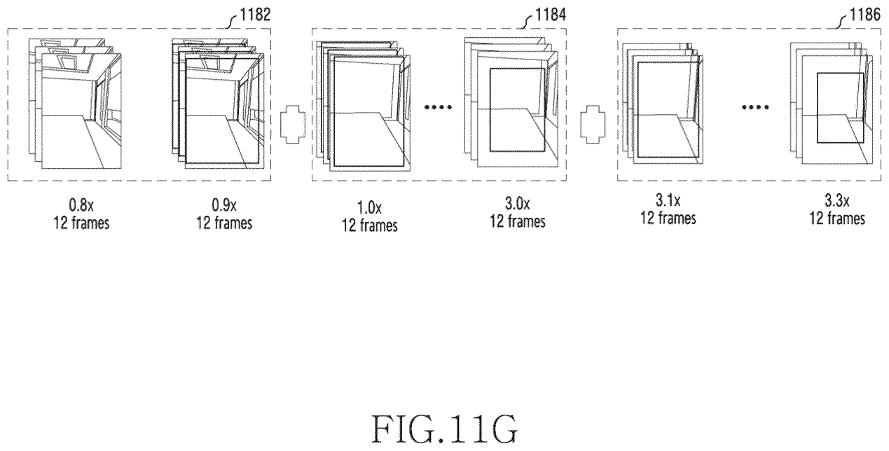

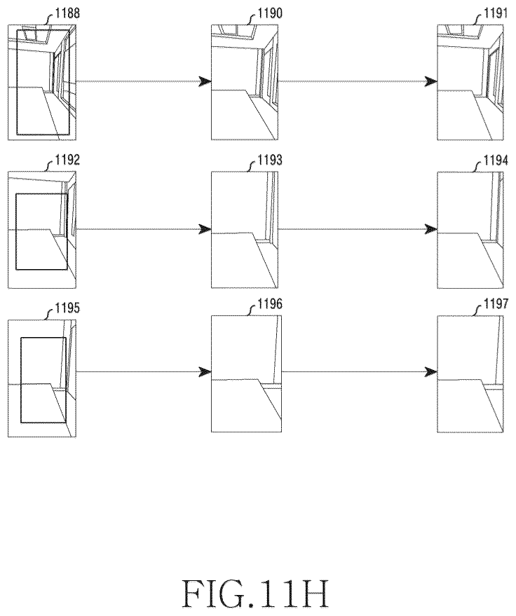

In generating the video with the vertigo effect, the generating module 208 may be configured to discard one or more additional frames associated with the one or more backgrounds and the selected at least one segmented object based on the user desired frame rate and the determined range of zoom levels. For example, when the user-selected speed is greater than the recorded frame rate, then the frames of the video may be dropped to match the user desired frame rate. In an embodiment of the present disclosure, the one or more additional frames may be discarded upon determining that the user desired frame rate is lower than the current frame rate of the video. Further, the generating module 208 may be configured to obtain the set of merged frames by merging the frames associated with one or more backgrounds and the selected at least one segmented object other than the discarded one or more additional frames. The generating module 208 may be configured to generate the video with the vertigo effect by performing the fusion operation. In an embodiment of the present disclosure, the fusion operation may correspond to a fusion of the obtained set of merged frames associated with the video based on the type of vertigo effect. In an embodiment of the present disclosure, the obtained set of merged frames is fused at boundary zoom levels of the primary camera and the one or more secondary cameras. The details on the generation of the video with the vertigo effect have been elaborated in subsequent paragraphs at least with reference to FIGS. 11A, 11B, 11C, 11D, 11E, 11F, 11G, and 11H.

In an embodiment of the present disclosure, the total duration of the vertigo effect may be shown to the user. Total zoom range may be directly proportional to the total captured frames associated with the video. For example, the total vertigo effect generated may be of duration 10 secs with a zoom range of 0.6× to 2.0×. When user reduces the vertigo effect to 2 seconds, then frames (i.e., the one or more additional frames) may be dropped from two extreme ranges of zoom, that is, frames with the highest zoom level or lowest zoom level, resulting in zoom range to 1.2× to 1.0×. Further, when user reduces the vertigo effect to 5 secs, then frames may be dropped from two extreme ranges of zoom, resulting in zoom range to 1.4× to 0.9×. Furthermore, when user reduces the vertigo effect to 8 secs, then frames may be dropped from two extreme ranges of zoom, resulting in zoom range to 1.8× to 0.8×.

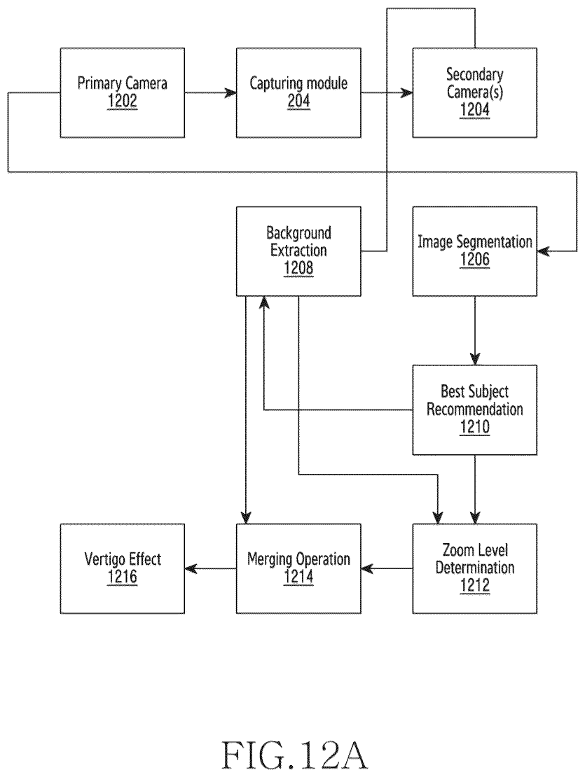

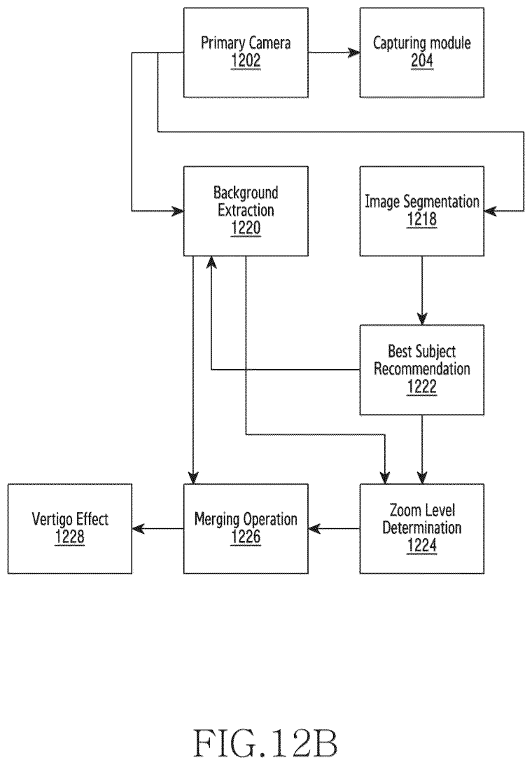

The details on operation of the system 102 for generating the video with vertigo effect have been elaborated in subsequent paragraphs at least with reference to FIGS. 12A and 12B.

FIG. 3 illustrates pictorial representations depicting use-case scenarios for determining a set of imaging parameters, according to an embodiment of the present disclosure. The details on the determination of the set of imaging parameters have been elaborated with respect to FIG. 3.

As depicted, FIG. 3 shows three cases i.e., case I 302, case II 304, and case III 306. In case I 302, the system 102 sets the imaging parameters to detect the number of segmented objects and accuracy of the segmentation as the EV: 2.0, ISO: 3200, aperture: F1.8, and shutter speed: 1/110 seconds. Further, the outcome of case I 302 is segmented objects with high accuracy i.e., 3 objects.

Further, in case II 304, the system 102 sets the imaging parameters to detect the number of segmented objects and accuracy of the segmentation as: the EV: 0.0, ISO: 3200, ae: F1.8, and shutter speed: 1/10 seconds. Further, the outcome of case II 304 is segmented objects with high accuracy i.e., 6 units.

Furthermore, in case III 306, the system 102 sets the imaging parameters to detect the number of segmented objects and accuracy of the segmentation as: the EV:-2.0, ISO: 3200, Aperture: F1.8, and shutter speed: 1/1957 seconds. Further, the outcome of case III 306 is segmented objects with high accuracy i.e., 1 unit. Thus, the system 102 may identify the case II 304 as the best scenario and accordingly recommends the imaging parameters as EV: 0.0, ISO: 3200, aperture: F1.8, and shutter speed: 1/10 seconds to the primary camera and the one or more secondary cameras to capture images.

FIG. 4 illustrates a block diagram 400 depicting a training process of the reinforcement learning-based AI model, according to an embodiment of the present disclosure. Details on the determination of the set of imaging parameters by using the reinforcement learning-based AI model have been elaborated in FIG. 2.

As depicted, the capturing module 202 may correspond to a feedback loop for training the reinforcement learning-based AI model. The capturing module 202 may include a parameter suggester 402 i.e., Deep Neural network (DNN)-based interpreter, and an image segmentation unit 404. In an embodiment of the present disclosure, the parameters suggester 402 may receive an image 406 captured by the primary camera 408 and outputs one or more imaging parameters, such as EV, ISO, shutter speed, aperture, and the like for further capturing. Further, the primary camera 408 may further capture images based on the one or more imaging parameters. the image segmentation unit 404 may segment the image 406 into object maps. Furthermore, the image segmentation unit 404 may segment the images captured based on the suggested imaging parameters, into object maps. Further, multiple buffers 410 may be created for storing the set of objects maps for each combination of the one or more imaging parameters.

In an embodiment of the present disclosure, the training of the reinforcement learning-based AI model may work on the basis of state-based reinforcement learning model, action-based reinforcement learning model, or reward-based reinforcement learning model, but is not limited thereto. In state-based reinforcement learning model, the parameter suggester 402 may suggest the one or more imaging parameters for the scene. In action-based reinforcement learning model, the primary camera 408 may capture the at least one first image based on the one or more imaging parameters, such that the at least one first image is segmented into the set of object maps. Further, in the reward-based reinforcement learning model, the set of object maps is fed back to the parameter suggester 402. In an embodiment of the present disclosure, the reinforcement learning-based AI model may learn this reward and attempt multiple combinations of the one or more imaging parameters to maximize the reward i.e., maximize the number of objects segmented in a particular scene. The reinforcement learning-based AI model trains itself to suggest such imaging parameters for a scene to maximize the number of segmented objects in the scene.

FIGS. 5A and 5B are diagrams illustrating identification of the one or more secondary cameras from the set of secondary cameras required to capture the at least one second image, according to an embodiment of the present disclosure. Details on the identification of the one or more secondary cameras from the set of secondary cameras have been elaborated in FIG. 2.

In an embodiment of the present disclosure, the capturing module 202 of the system 102 may trigger one or more secondary cameras of the electronic device to capture the at least one second image. FIG. 5A depicts the use-case scenario of triggering the one or more secondary cameras when the primary camera 408 of the electronic device is a wide-angle camera. The image 502 represents an image from the wide-angle camera. For example, to support the zoom-out range of 0.5×-1×, the capturing module 202 may trigger the one or more secondary cameras with the higher FoV based on secondary camera configurations. In this scenario, the FoV of the ultra-wide camera is greater than the primary camera 408. Hence, the capturing module 202 may trigger the ultra-wide camera as the one or more secondary cameras to obtain more background scene details. The image 504 represents an image from the ultra-wide camera. In another example, to support the zoom-in range of 2×-4×, the capturing module 202 may trigger one or more secondary cameras with better optical zoom capability based on the secondary camera configuration. In this scenario, a tele-camera has a better optical zoom capability at a higher zoom level. Hence, the capturing module 202 may trigger the tele-camera as the one or more secondary cameras. The image 506 represents an image from the tele-camera.

FIG. 5B depicts the use-case scenario of triggering one or more secondary cameras when the primary camera is a macro camera. The image 508 represents an image from the macro camera. For example, to support a zoom-out range of 4×-1×, the capturing module 202 may trigger the one or more secondary cameras with the higher FoV based on the secondary camera configuration. In this scenario, the FoV of a wide camera is greater than the primary camera. Hence, the capturing module 202 may trigger the wide camera as the one or more secondary cameras to obtain more background scene details. The image 510 represents an image from the wide camera. In another example, to support a zoom-out range of lower than 1×, the capturing module 202 may trigger the one or more secondary cameras with a higher FoV based on the auxiliary camera configuration. In this scenario, the FoV of the ultra-wide camera is greater than the primary camera. Hence, the capturing module 202 may trigger the ultra-wide camera as the one or more secondary cameras to obtain more background scene details. The image 512 represents an image from the ultra-wide camera.

FIG. 6 is a diagram illustrating segmentation of the at least one first image and the at least one second image into the set of objects, in accordance with an embodiment of the present disclosure. Details on the segmentation of the at least one first image and the at least one second image into the set of objects have been elaborated in FIG. 2.

FIG. 6 depicts the segmentation of an image into multiple objects. The image on which image segmentation is performed may be a first image captured by the first camera. Similarly, the at least one second image may be also segmented into the multiple objects. In an embodiment of the present disclosure, the segmenting module 204 may be used for segmenting the at least one first image into the set of object maps for enabling the selection of the best subject. As a result, the main subject is kept in focus throughout the video. This will enable the further modules to select the best subject among the segmented set of subjects or provide the user an option to select the subject. The segmenting module 204 identifies each pixel and classifies each pixel into a group of pixels. Each pixel of the group of pixels is similar with respect to some characteristic or computed property, such as color, intensity, or texture. These groups of pixels form an object map that indicates each object.

As depicted in FIG. 6, the image segmenting module 204 segments the at least one first image 602 into the multiple object maps, such as object map I 604, object map II 606, and object map III 608.

FIG. 7 is a diagram illustrating selection of the one or more object maps from the set of object maps, in accordance with an embodiment of the present disclosure. Details on the selection of the one or more object maps from the set of object maps have been elaborated in FIG. 2.

As depicted, the selecting module 210 may receive a set of object maps 702 from the image segmenting module 204. Further, the selecting module 210 may automatically select an object map 704 from the set of object maps 702 based on a position of the set of object maps in the image on which the image segmentation has been performed. The object map 704 may be selected for generating the vertigo effect. For example, the object corresponding to a subject which is located at the center of the frame or closer to the camera may be suggested as an object for vertigo effect generation.

In an embodiment of the present disclosure, the user may select the object map 704 from the set of object maps 702 by providing the input/user input 706.

FIG. 8 is a diagram illustrating segmentation of at least one first image and the at least one second image into the one or more backgrounds, in accordance with an embodiment of the present disclosure. Details on the segmentation of the at least one first image and the at least one second image into the one or more backgrounds have been elaborated in FIG. 2.

As depicted in FIG. 8, images I 802 may be captured by a first secondary camera at 0.5×-1.0× zoom levels. Further, images II 804 may be captured by the primary camera at 1.0×-3.0× zoom levels. Images III 806 may be captured by a second secondary camera at 3.0×-6.0× zoom levels. Further, the selected at least one segmented object/object map 808 may be captured at 1× zoom level. As all the images (images I 802, images II 804, and images III 806) may have different FoV and zoom levels, the segmenting module 204 may identify a location of the selected at least one segmented object 808 and erase the selected at least one segmented object 808 from all the images 802, 804 and 806. Furthermore, the segmenting module 204 may scale the selected at least one segmented object 808 to match the zoom level of all the images 802, 804 and 806 to locate the selected at least one segmented object 808 in all the images 802, 804 and 806. For example, as depicted in images 810, the segmenting module 204 may scale down the selected at least one segmented object 808 from 1× to 0.5× for some of the images I 802 at 0.5×. As depicted in images 812, the selected at least one segmented object 808 may be scaled up from 1× to 1.5× for some of the images II 804 at 1.5×. As depicted in images 814, the selected at least one segmented object 808 may be scaled up from 1× to 3.2× for some of the images III 806 at 3.2×. Further, the selected at least one segmented object 808 may be located and erased in all the images 810, 812 and 814. The empty pixels associated with the erased at least one segmented object are then reconstructed using the one or more image in-painting techniques to generate the one or more backgrounds. In an embodiment of the present disclosure, the image in-painting technique corresponds to a task of reconstructing missing regions in an image.

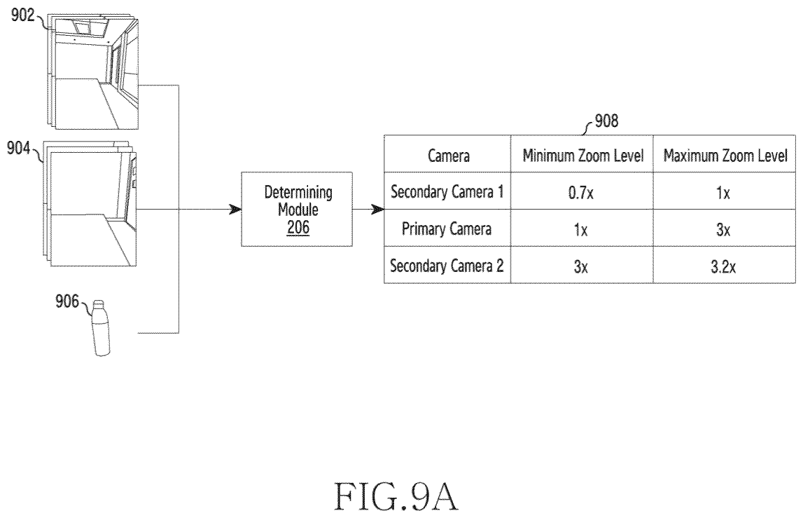

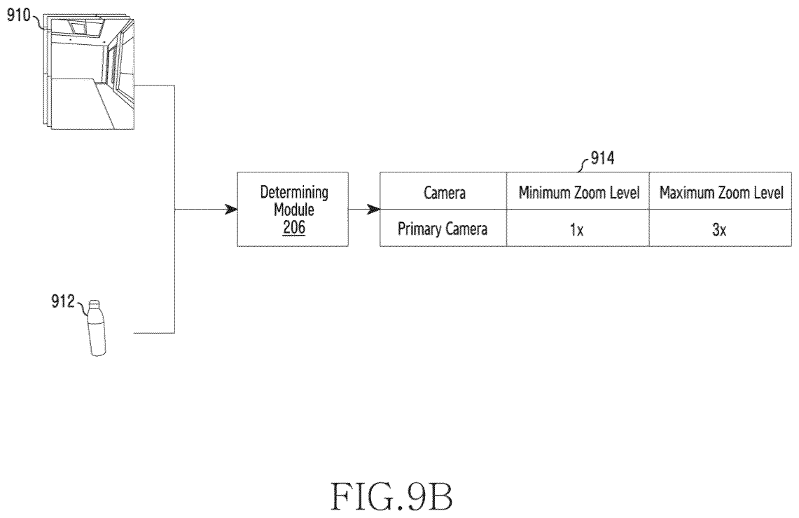

FIGS. 9A and 9B are diagrams illustrating use-case scenarios for determining the range of zoom levels for generating the vertigo effect, in accordance with an embodiment of the present disclosure. For the sake of brevity, FIGS. 9A and 9B are explained together. Details on the determination of the range of zoom levels for generating the vertigo effect have been elaborated in FIG. 2.

FIG. 9A shows a use case scenario of an extracted background I 902 from a first secondary camera, an extracted background II 904 from a second secondary camera, and an object map 906 from a primary camera. In an embodiment of the present disclosure, the determining module 206 may identify zoom levels for each camera as shown in Table I 908. For the first secondary camera, a minimum suggested zoom level may be 0.7× and a maximum suggested zoom level may be 1×. Further, for the primary camera, a minimum suggested zoom level may be 1× and a maximum suggested zoom level may be 3×. Furthermore, for the second secondary camera, a minimum suggested zoom level may be 3× and a maximum suggested zoom level may be 3.2×. The video with the vertigo effect may be generated based on images with the zoom range of global minimum zoom level and global maximum zoom level out of all these values. In this use case scenario, the global minimum zoom level is 0.7× and the global maximum zoom level is 3.2×.

FIG. 9B shows a use case scenario of an extracted background I 910 from a primary camera and an object map 912 from the primary camera. In an embodiment of the present disclosure, the determining module 206 may identify zoom levels for the primary camera as shown in Table II 914. In the present use-case scenario, the suggested zoom levels for the primary camera are 1× of a minimum suggested zoom level and 3× of a maximum suggested zoom level.

FIGS. 10A, 10B, 10C and 10D are diagrams illustrating determination of the range of zoom levels for generating the vertigo effect, in accordance with an embodiment of the present disclosure. For the sake of brevity, FIGS. 10A, 10B, 10C and 10D are explained together. Details on the determination of the range of zoom levels for generating the vertigo effect have been elaborated in FIG. 2.

FIG. 10A depicts the training of the AI model for determining a range of zoom levels by considering a size ratio between the selected at least one segmented object 1010 and the one or more segmented objects 1006 and 1008 other than the selected at least one segmented object 1010 from the segmented set of objects. Multiple realistic vertigo effect videos may be recorded manually for zooming in/out. In an embodiment of the present disclosure, these realistic vertigo effect videos may have zoom-in and zoom-out frames optimal for a specific scene. The optimal zoom-in or zoom-out frames may not contain any pixilation of background objects or foreground objects. Thus, aesthetics of the scene may be preserved in every frame. Further, a dataset may be prepared from these realistic vertigo effect videos with an input frame 1002 to the AI model and a ground truth frame 1004, as shown in FIG. 10A. The input frame 1002 shows the size ratio of multiple secondary objects 1006 and 1008 with respect to the primary object 1010. Further, the input frame 1002 also shows the position of the multiple secondary objects 1006 and 1008 with respect to the primary object 1010 in the frame. Further, 1012 depicts a predicted output/predicted frame of the AI model i.e., size ratio up to which the multiple secondary objects 1006 and 1008 is zoomed in/out. In the ground truth frame 1004, an optimal size ratio up to which the multiple secondary objects 1006 and 1008 is zoomed in/out may be determined for a realistic vertigo effect. In an embodiment of the present disclosure, the difference between the predicted output 1012 and the ground truth frame 1004 may be determined and minimized using a loss function. In an embodiment of the present disclosure, the ground truth frame 1004 may have a final size ratio between primary object 1010 and secondary objects 1006 and 1008, up to which vertigo effect may seem realistic for a particular secondary object in the image. Further, the AI model may be trained using backpropagation. In an embodiment of the present disclosure, weights are then fine-tuned using the backpropagation. For example, a size ratio of the input frame 1002 may be 3/1, a size ratio of the predicted output 1012 may be 3/5, and a size ratio of the ground truth 1004 may be 3/2, but is not limited thereto. In an embodiment of the present disclosure, the size ratio corresponds to a size of the primary object/a size of the secondary object.

In an embodiment of the present disclosure, the input frame 1002 and its ground truth frame 1004 may be selected for training the AI model in the following manner: the input frame 1002 (first frame of the vertigo effect) and zoomed-in frame (second frame of the vertigo effect) may be 0.1× in zoom level compared to the first frame. Further, the input frame 1002 (first frame of the vertigo effect) and zoomed-in (the third frame of the vertigo effect) may be 0.2× in zoom level as compared to first frame. Furthermore, the first frame and the zoomed-out frame may be selected as the input frame 1002 and the ground truth frame 1004. Further, size ratio information, based on the primary and secondary object size in the frame, may be computed and saved for every frame. For an optimal zoom-in or zoom-out effect, the size ratio for a frame may be greater than or equal to 1.0. For example, in the size ratio of 3/5, if the secondary object is zoomed, the ratio becomes lower than 1.0×, and hence, the frame may look pixelated.

As the AI model is trained with the input frame 1002, zoom-in frames, and zoomed-out frames, the AI model may learn to restrict the predicted zoom-in or zoom-out frame, such that the size ratio becomes greater than or equal to 1.0. Thus, the predicted zoom range may be optimized. During training, even if the AI model predicts a zoomed frame whose size ratio comes to 3/5, the loss function may try to restrict the size ratio to greater than 1.0× such that the predicted zoom level frame may be in an optimal range.

In an embodiment, a range of zoom levels may be determined based on a proportion occupied by the object 1006 or 1008 to the selected object 1010 or backgrounds. For example, the range of zoom levels (such as a lowest zoom level and a highest zoom level of the range of zoom levels) may be identified by the proportion, occupied by the object 1006 or 1008, to the selected object 1010 or the backgrounds exceeding a threshold range.

As depicted in FIG. 10B, a first frame 1012, a second frame 1014, and a third frame 1016 may be used for the zooming-out vertigo effect on a main object (a chair). However, after zoom-level exceeding a threshold 1018, secondary objects near the main object may be covered or hidden by the main object or secondary objects far from the main object may be not visible, so the secondary objects may look unrealistic considering the whole scene, as shown in the fourth frame 1020 and the fifth frame 1022. Hence, the AI module may be trained with many videos like this, such that the AI model learns to suggest the optimal zoom level for the realistic vertigo effect.

FIG. 10C depicts the training of the AI model for determining the range of zoom levels by considering the similarity index between background of the at least one first image and the at least one second image with varying zoom levels. As depicted, multiple extracted backgrounds from different cameras may be passed through a Convolutional Neural Network (CNN) block. In an embodiment of the present disclosure, images 1024 represent extracted background images from the first secondary camera with zoom range of 0.5× to 1.0×, images 1026 represent extracted background images from the primary camera with zoom range of 1.0× to 3.0×, and images 1028 represent extracted background images from the second secondary camera with zoom range of 3.5× to 6.0×. The CNN block 1030 may output a feature vector 1032 for every background at different zoom levels. Further, the similarity index 1034 may be calculated between consecutive frames ranging from minimum to maximum zoom level 1036 as per the camera capability. For example, when images 1024, 1026 and 1028 are available from 0.5× to 6.0× zoom level, the comparison may begin from a zoom level of 0.5× and/or 6.0×. When it is determined that frames have similar features from 0.5× zoom level to 0.8× zoom level, then the minimum suggested zoom level may be set as 0.8×. For example, when it is determined that frames have similar features from 6.0× to 4.5×, then the maximum zoom level may be set as 4.5×. As a result, 0.8×-4.5× may be determined as the suggested zoom level range.

As depicted in FIG. 10D, a first frame 1038, a second frame 1040, and a third frame 1042 are used for the zooming-in vertigo effect. However, after a zoom level exceeding a threshold 1044, there seems to be no change in the background while zooming-in the background (as shown in a fourth frame 1046 and a fifth frame 1048). Hence, the determining module 206 may determine a zoom level reaching the threshold 1044 as a zoom range level (such as a maximum zoom level). The AI module may compare the background feature vectors for similarity index to decide the optimal zoom level. Similarly, even if the background is zoomed out, there may seem to be no change in the background. Hence, the determining module 206 may suggest a zoom level at which no changes are detected in the background as a zoom level range (such as a minimum zoom level). The AI module may compare the background feature vectors for similarity to decide the optimal zoom level.

FIG. 11A is a block diagram depicting a process of generating the vertigo effect, in accordance with an embodiment of the present disclosure. Further, FIG. 11B is a block diagram depicting a process of generating the vertigo effect, in accordance with an embodiment of the present disclosure. Furthermore, FIG. 11C is a diagram illustrating a process of obtaining a set of merged frames, in accordance with an embodiment of the present disclosure.

Further, FIG. 11D is a diagram illustrating use-case scenarios for selection of a frame for a corresponding zoom value, in accordance with an embodiment of the present disclosure. Further, FIG. 11E is a diagram illustrating obtaining the set of merged frames in a zooming-in scenario, in accordance with an embodiment of the present disclosure. Furthermore, FIG. 11F is a diagram illustrating obtaining the set of merged frames in a zooming-out scenario, in accordance with an embodiment of the present disclosure. FIG. 11G is a diagram illustrating sequential merging of frames, in accordance with an embodiment of the present disclosure. Further, FIG. 11H is a diagram illustrating sequential merging of frames at different resolutions, in accordance with an embodiment of the present disclosure. For the sake of brevity, FIGS. 11A, 11B, 11C, 11D, 11E, 11F, 11G, and 11H are explained together. Details on the generation of the vertigo effect have been elaborated in FIG. 2.

As depicted in FIG. 11A, the generating module 208 may scale up or down a set of object maps based on a zoom level range of one or more backgrounds to obtain at least one intermediate frame. Further, a video with a vertigo effect may be generated by fusing set of merged frames and the at least one intermediate frame. If frames associated with the video are recorded at a frame rate different than a user selected frame rate, then the generating module 208 may interpolate frames to match the selected frame rate. At step 1102, a video frame interpolation may be performed based on at least one segmented object (or object map) and its zoom level 1104, a determined range of zoom levels 1106, the one or more backgrounds and their zoom levels 1108, and a user selected frame rate and a duration for the vertigo effect 1110. The output of the video frame interpolation may include the at least one intermediary frame (i.e., a modified extracted background and a modified at least one segmented object) 1112. Further, at step 1114, a blending/merging operation may be performed by merging/blending the frames associated with the one or more backgrounds and a selected object map, and the obtained at least one intermediary frame. The output of the blending operation may include a set of merged frames 1116. Further, at step 1118, the video with the vertigo effect 1120 may be generated by fusing the obtained set of merged frames associated with the video based on the type of vertigo effect (i.e., the zooming-in vertigo effect and the zooming-out vertigo effect).

As depicted in FIG. 11B, at step 1122, the blending operation may be performed on a first modified extracted background 1124 associated with the first secondary camera, a modified extracted background 1126 associated with the primary camera, a second modified extracted background 1128 associated with the second secondary camera, and a selected at least one segmented object (not shown). The result of the blending operation may include a set of merged/blended frames (i.e., a first blended extracted background 1132, a blended extracted background 1134, and a second blended extracted background 1136). At step 1138, the fusion operation may be performed on the set of merged frames for generating the video with the vertigo effect 1140.

As depicted in FIG. 11C, an image 1142 represents a background associated with the first secondary camera (at zoom level 0.9×), an image 1144 represents a background associated with the primary camera (at zoom level 1.2×), an image 1146 represents a background associated with the second secondary camera (at zoom level 3.2×), and an image 1148 represents a selected segmented object. The images 1142 may include a plurality of images, each of which representing the background associated with the first secondary camera with a zoom range of 0.7× to 1.0×. The images 1144 may include a plurality of images, each of which representing the background associated with the primary camera with a zoom range of 1.0× to 3.0×. The images 1146 may include a plurality of images, each of which representing the background associated with the second secondary camera with a zoom range of 3.0× to 3.2×. At step 1150, the blending operation may be performed for each frame of the cameras. Further, images 1152 represent the blended/merged frames for the first secondary camera with a zoom range of 0.7× to 1.0×, images 1154 represent the blended/merged frames for the primary camera with a zoom range of 1.0× to 3.0×, and images 1156 represent the blended/merged frames for the second secondary camera with a zoom range of 3.0× to 3.2×. In an embodiment of the present disclosure, blended frame images (1152, 1154, and 1156), in order, correspond to an increasing zoom level of backgrounds. In an embodiment of the present disclosure, the primary object, indicated by the image 1148, remains of the same size.

In an embodiment of the present disclosure, all cameras (the primary camera and the one or more secondary cameras) may be running at the same Frames Per Second (FPS), such that all frames are captured from all the cameras for multiple timestamps. Based on the zoom-in and zoom-out operations, digital cropping may be performed for frames associated with the one or more secondary cameras. In an embodiment of the present disclosure, the image quality of digitally cropped frame's resolution is lower as compared to non-cropped frames. Based on the zooming direction and the determined range of zoom levels, the generating module 208 may select the multiple frames captured by all the cameras for generating the vertigo effect. For example, if the zoom direction toward the subject (i.e., zooming-in), the zoom value for the frames associated with the one or more secondary cameras may be 0.8× (the first secondary camera), 0.9× (the first secondary camera), 1× (the primary camera), 1.5× (the primary camera), 3.0× (the second secondary camera), and 3.2× (the second secondary camera). In another example, if the zoom direction is away from the subject (i.e., zooming-out), the zoom value for the frames associated with the one or more secondary cameras may be 3.2× (the second secondary camera), 3.0× (the second secondary camera), 1.5× (the primary camera), 1× (the primary camera), 0.9× (the first secondary camera), and 0.8× (the first secondary camera). In an embodiment of the present disclosure, the selection of the frames for generating the vertigo effect, across the one or more secondary cameras, may be performed based on the zoom value available with better image quality.

As shown in FIG. 11D, an image 1158 shows a use-case scenario for selecting a frame 1160 for zoom value to 0.8× in the image 1158 at 0.5× zoom, captured by the first secondary camera. In an embodiment, a digital cropping may be performed for the image 1158 of 0.8× zoom, resulting in the frame 1160. In an embodiment of the present disclosure, a digital cropped frame 1160 may have a resolution of 1400*580, but is not limited thereto. Further, image 1162 shows a use-case scenario for selecting a frame for zoom value to 1×. Furthermore, an image 1164 represents a frame captured by the first secondary camera running at 0.5× zoom. Further, a box 1166 represents the digital cropping for 1.0× zoom. In an embodiment of the present disclosure, a digital cropped image may have a resolution of 1100*320, but is not limited thereto. Further, an image 1168 represents a frame captured by the primary camera running at 1× zoom. In an embodiment of the present disclosure, the image 1168 may have a resolution of 1920*1080, but is not limited thereto. In an embodiment of the present disclosure, a zoom level of 1.0× may be available in both the first secondary camera and the primary camera. When resolution of primary camera frame is higher than the first secondary camera a frame of zoom level of 1.0× may be obtained from the primary camera.

As shown in FIG. 11E, images 1170 represent frames captured by the first secondary camera at 0.5× zoom level. Further, images 1172 represent frames captured by the primary camera at 1.0× zoom level. Furthermore, images 1174 represent frames captured by the second secondary camera at 3.0× zoom level. In an embodiment of the present disclosure, a tick symbol represents that ticked frames are selected for generating the zooming-in vertigo effect. Images of 0.6× and 0.9× zoom levels may be extracted (or cropped) from the images 1170 of 0.5× zoom level. Images of 3× may be extracted (or cropped) from the images 1172 of 1.0× zoom level. Images of 3.1× and 3.2× zoom level may be extracted (or cropped) from the images 1174 of 3.0× zoom level, but is not limited thereto.

As shown in FIG. 11F, images 1176 represent frames captured by the first secondary camera at 0.5× zoom level. Further, images 1178 represent frames captured by the primary camera at 1.0× zoom level. Furthermore, images 1180 represent frames captured by the second secondary camera at 3.0× zoom level. In an embodiment of the present disclosure, a tick symbol represents that ticked frames are selected for generating the zooming-out vertigo effect.

Further, FIG. 11G shows a sequential merging of frames. For example, all cameras (the first secondary camera, the primary camera, and the second secondary camera) may take pictures for 5 seconds at 60 FPS. In the current scenario, all cameras may run in parallel, such that 300 frames may be captured by each camera for same timeline. In an embodiment of the present disclosure, auto zoom level identified may be 0.8×-3.3× (i.e.; 25 zoom levels 0.8,0.9,1.0,1.1,1.2, . . . ,3.3). To produce final vertigo effect of 5 seconds at 60 FPS, 300 frames are required. For smooth zoom transition, each zoom level may have equal number of frames (i.e., 300 frames/25 zoom levels=12 frames per zoom level). For example, the number of frames may be: 12 frames for zoom level 0.8×, 12 frames zoom level 0.9×, 12 frames for zoom level 1.0×, . . . , 12 frames for zoom level 3.3×. For better resolution at a particular zoom level, 0.8×-0.9× (2 zoom levels 0.8, and 0.9) frames 1182 may be obtained from the first secondary camera (i.e., 12 frames*2 zoom level=24 frames). Frames of 0.9× zoom level are extracted (or cropped) from images of 0.8× zoom level as indicated by boxes in the images. In an embodiment of the present disclosure, frames of frame numbers 1-24 may be selected out of 300 frames of the first secondary camera. Further, 1.0×-3.0× (i.e., 20 zoom levels 1.0,1.1, . . . ,3.0) frames 1184 may be obtained from the primary camera (i.e., 12 frames*20 zoom level=240 frames). In an embodiment of the present disclosure, frames of a frame numbers 25-244 may be selected out of 300 frames of the primary camera. Furthermore, 3.1×-3.3× (i.e., 3 zoom levels 3.1, 3.2, and 3.3) frames 1186 may be obtained from the second secondary camera (i.e., 12 frames*3 zoom level=36 frames). Frames of 3.1× and 3.2× zoom levels are extracted (or cropped) from images of 3.0× zoom level as indicated by boxes in the images. In an embodiment of the present disclosure, frames of frame numbers 245-300 may be selected out of 300 frames of the second secondary camera.

Furthermore, FIG. 11H shows a sequential merging of frames at different resolutions. In case of multiple cameras, the images may be cropped and scaled to match the resolution as selected by the user like, such as High Definition (HD), Full High Definition (FHD), Ultra High Definition (UHD), and the like from the primary camera. Frames from each camera may be processed by performing cropping and scaling. In cropping, the zoomed region may be extracted. In scaling, an upscaling operation or a downscaling operation may be performed on the extracted images to match selected image resolution of the primary camera.

As depicted, an image 1188 represents a first image captured by the first secondary camera at 0.6×. Further, the first image 1188 may be cropped to obtain a first cropped image 1190. Further, the first cropped image 1190 may be scaled to match the HD resolution. As a result, a first scaled image 1191 is obtained. Furthermore, an image 1192 represents a second image captured by the primary camera at 1×. Further, the second image 1192 may be cropped to obtain a second cropped image 1193. Further, the second cropped image 1193 may be scaled to match the HD resolution. As a result, a second scaled image 1194 is obtained. An image 1195 represents a third image captured by the second secondary camera at 3.2×. Further, the third image 1195 may be cropped to obtain a third cropped image 1196. Further, the third cropped image 1196 may be scaled to match the HD resolution. As a result, a third scaled image 1197 is obtained.

FIGS. 12A and 12B illustrate block diagrams depicting the operation of the system 102 for generating the video with vertigo effect, according to an embodiment of the present disclosure. For the sake of brevity, FIGS. 12A and 12B are explained together. Details on the system 102 configured to generate the vertigo effect have been elaborated in FIGS. 1 and 2.

As shown in FIG. 12A, the primary camera 1202 and the one or more secondary cameras 1204 may be used for generating the video with vertigo effect. The primary camera 1202 may share or transfer an image preview and a primary camera zoom level (first FoV) to the capturing module 202. Further, the capturing module 202 of the system 102 may determine a set of imaging parameters and triggers the one or more secondary cameras 1204 to capture at least one second image by using the determined set of imaging parameters. In an embodiment of the present disclosure, the set of imaging parameters may be also shared with or transferred to the primary camera 1202 to capture at least one first image. At step 1206, the system 102 may segment the captured at least one first image into a set of objects (object maps), but is not limited thereto. The system 102 may segment the captured at least one second image into the set of objects. At step 1208, the system 102 may segment the captured at least one second image into one or more backgrounds, but is not limited thereto. The system 102 may segment the captured at least one first image into the one or more backgrounds. Further, at step 1210, the system 102 may select one or more object maps from obtained set of object maps based on either the user input or automatic selection without the user input. At step 1212, the system 102 may determine a range of zoom levels for the vertigo effect based on the selected object map and the one or more backgrounds, but is not limited thereto. The system 102 may determine the range of zoom levels based on a first FoV of the primary camera 1202, second FoVs of the secondary cameras 1204, at least one selected object from the segmented set of objects, the one or more segmented objects other than the selected at least one segmented object from the segmented set of objects, the segmented one or more backgrounds, or any combination thereof. At step 1214, the system 102 may generate the video with the vertigo effect 1216 by using the segmented one or more backgrounds, the determined range of zoom levels, and the selected at least one segmented object. For example, the system 102 may generate the video including the selected object and the segmented backgrounds with zoom levels varying within the determined range of zoom levels.

As shown in FIG. 12B, only the primary camera 1202 may be used for generating the video with vertigo effect. The primary camera 1202 may share or transfer an image preview and the first FoV to the capturing module 202. Further, the capturing module 202 of the system 102 may determine a set of imaging parameters. In an embodiment of the present disclosure, the set of imaging parameters may be also shared with or transferred to the primary camera to capture at least one first image. At step 1218, the system 102 may segment the captured at least one first image into a set of objects (object maps). At step 1220, the system 102 may segment the captured at least one first image into one or more backgrounds. Further, at step 1222, the system 102 may select one or more object maps from the obtained set of object maps based on either the user input or automatic selection without the user input. At step 1224, the system 102 may determine a range of zoom levels for the vertigo effect based on the selected object map and the one or more backgrounds, but is not limited thereto. The system 102 may determine the range of zoom levels based on a first FoV of the primary camera 1202, the selected one or more objects, the one or more segmented objects, the segmented one or more backgrounds, or any combination thereof. At step 1226, the system 102 may generate the video with the vertigo effect 1228 by using the segmented one or more backgrounds, the determined range of zoom levels, and the selected at least one segmented object. For example, the system 102 may generate the video including the selected object and the segmented backgrounds with zoom levels varying within the determined range of zoom levels.

In an embodiment of the present disclosure, the system 102 may also generate the vertigo effect for an offline recorded video. The system 102 may segment each frame of the offline recorded video into a set of objects (object maps). Further, the system 102 may segment each frame of the offline recorded video into one or more backgrounds. Furthermore, the system 102 may select one or more object maps from the obtained set of object maps based on either the user input or automatic selection without the user input. The system 102 may determine a range of zoom levels for the vertigo effect based on the selected object map and the one or more backgrounds, but is not limited thereto. The system 102 may determine the range of zoom levels based on the selected one or more objects, the segmented one or more objects, the segmented one or more backgrounds, or any combination thereof. Further, the system 102 may generate the video with the vertigo effect by using the segmented one or more backgrounds, the determined range of zoom levels, and the selected at least one segmented object. For example, the system 102 may generate the video including the selected object and the segmented backgrounds with zoom levels varying within the determined range of zoom levels.

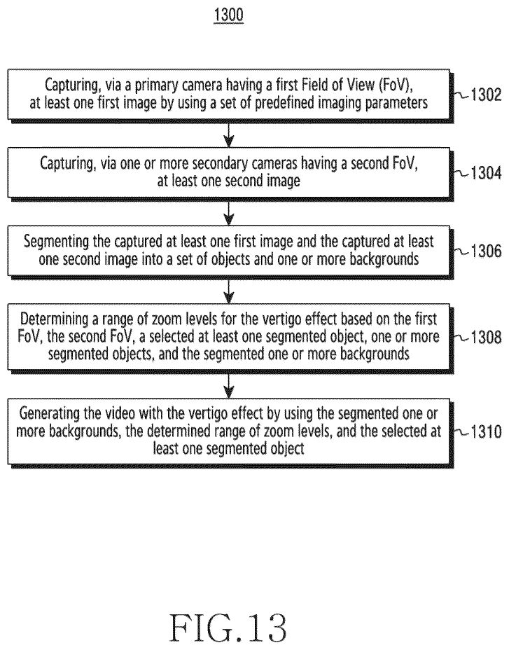

FIG. 13 is a flow diagram illustrating a method for generating the video with vertigo effect, in accordance with an embodiment of the present disclosure. In an embodiment of the present disclosure, the method 1300 is performed by the system 102, as explained with reference to FIGS. 1 and 2.

According to an embodiment, the method 1300 may include obtaining at least one first image by capturing a subject via a first camera. The first camera may be referred to as a primary camera. For example, at step 1302, the method 1300 may include capturing, via the primary camera having a first Field of View (FoV), the at least one first image by using a set of predefined imaging parameters. The first image may be included in the at least one first image. In an example embodiment of the present disclosure, the set of predefined imaging parameters may include Exposure Value (EV), International Organization for Standardization (ISO) value, shutter speed, aperture for a scene, or any combination thereof.

According to an embodiment, the method 1300 may include obtaining at least one second image with varying zoom levels by capturing the subject via a second camera. The second camera may be referred to as a secondary camera. For example, at step 1304, the method 1300 may include capturing, via one or more secondary cameras having a second FoV, the at least one second image.

According to an embodiment, the method 1300 may include identifying an object corresponding to the subject from the first image, and identifying backgrounds from the second image. For example, at step 1306, the method 1300 may include segmenting the captured at least one first image and the captured at least one second image into the set of objects and the one or more backgrounds. The identified object may be one of the set of objects. In an embodiment of the present disclosure, each of the one or more backgrounds may include a background image associated with the captured at least one first image and the captured at least one second image.

According to an embodiment, the method 1300 may include determining a zoom level range (which may be referred to as a range of zoom levels) based on the object and the backgrounds. For example, at step 1308, the method 1300 may include determining the range of zoom levels for the vertigo effect based on the first FoV, the second FoV, the selected at least one segmented object from the segmented set of objects, the one or more segmented objects other than the selected at least one segmented object from the segmented set of objects, the segmented one or more backgrounds, or any combination thereof.

According to an embodiment, the method 1300 may include generating a video including the object, and the backgrounds with zoom levels varying within the range of zoom levels determined at step 1308. For example, at step 1310, the method 1300 may include generating the video with a vertigo effect by using the segmented one or more backgrounds, the determined range of zoom levels, and the selected at least one segmented object.

While the above steps shown in FIG. 13 are described in a particular sequence, the steps may occur in variations to the sequence in accordance with various embodiments of the present disclosure. Further, the details related to various steps of FIGS. 13, which are already covered in the description related to FIGS. 1-12 are not discussed again in detail here for the sake of brevity.

The present disclosure provides for various technical advancements based on the key features discussed above. Further, the present disclosure increases the zoom range for the vertigo effect automatically and provides the user with the capability of creating variations of the vertigo effect (i.e., zoom-in vertigo effect and zooming-out vertigo effect) post-capturing the video to increase the user's experience. Further, the present disclosure allows the user to generate the vertigo effect using a single tap of a capture button. The present disclosure identifies, by using the first FoV and the set of imaging parameters, one or more secondary cameras from a set of secondary cameras required to capture the at least one second image. The set of imaging parameters is computed, such that maximum segmentation of the objects may be obtained in the scene.

Further, the one or more secondary cameras capture the at least one second image at varying zoom levels to obtain maximum zooming range in the vertigo effect. Varying zoom levels for each of the one or more secondary cameras are computed based on the scene and the zooming capability of the primary camera and the one or more secondary cameras. During vertigo effect creation, the user has a choice to select the segmented set of objects to generate different types of vertigo effects.

Also, the present disclosure does not require the user to move physically/manually to generate the vertigo effect as the present disclosure uses the primary camera' and the one or more secondary camera's FoV to capture most of the information from the scene. Hence, automating the physical movement of the primary camera and the one or more secondary cameras to capture wider FOV. In an embodiment of the present disclosure, the present disclosure allows the user to capture the vertigo effect without moving or panning the primary camera by using the one or more secondary cameras. This gives the advantage of generating the vertigo effect with varying zoom levels. As there is an option for the user to select at least one segmented object from the segmented set of objects, various vertigo effects may be generated for the same scene. The present disclosure facilitates offline creation or editing of the vertigo effect from the recorded video files.

The plurality of modules 106 may be implemented by any suitable hardware and/or set of instructions. Further, the sequential flow associated with the plurality of modules 106 illustrated in FIG. 2 is an example and the embodiments may include the addition/omission of steps as per the requirement. In some embodiments, the one or more operations performed by the plurality of modules 106 may be performed by the one or more processors 104 based on the requirement.

According to an embodiment of the present disclosure, a method is provided. The method may include obtaining a first image by capturing a subject via a first camera. The method may include identifying an object corresponding to the subject from the first image. The method may include obtaining a plurality of second images with varying zoom levels by capturing the subject via a second camera. The method may include identifying a plurality of backgrounds from the plurality of second images. The method may include determining a zoom level range based on the object and the plurality of backgrounds. The method may include generating a video comprising the object, and the plurality of backgrounds with zoom levels varying within the determined zoom level range.

According to an embodiment, the first image may be associated with first imaging parameters comprising an exposure value (EV), an international organization for standardization (ISO), a shutter speed, or an aperture; and the obtaining the plurality of second images may include determining second imaging parameters based on analyzing a scene of the first image, and obtaining the plurality of second images by capturing the subject based on the second imaging parameters via the second camera.

According to an embodiment, the obtaining the plurality of second images may include identifying the second camera among a plurality of second cameras other than the first camera based on a supported zoom level range of the first camera, and obtaining the plurality of second images by capturing the subject via the identified second camera.

According to an embodiment, the first camera and the second camera may be the same.

According to an embodiment, the identifying the object may include performing image segmentation on the first image to generate an object map, and identifying the object indicated by the object map.

According to an embodiment, the identifying the object may include identifying a plurality of objects from the first image, and identifying the object by selecting the object from the plurality of objects.

According to an embodiment, the identifying the plurality of backgrounds may include identifying the plurality of backgrounds by excluding the object corresponding to the subject from the plurality of second images.

According to an embodiment, the identifying the plurality of backgrounds may further include identifying the plurality of backgrounds by reconstructing the plurality of second images in which the object is excluded.

According to an embodiment, the determining the zoom level range may include identifying similarity between the plurality of backgrounds, and identifying a lowest zoom level or a highest zoom level of the zoom level range based on the similarity exceeding a threshold.

According to an embodiment, the identifying the object may include identifying a plurality of objects from the first image, and identifying the object by selecting the object from the plurality of objects. According to an embodiment, the determining the zoom level range may include identifying a proportion occupied by a remaining object other than the identified object to the plurality of backgrounds, and identifying a lowest zoom level or a highest zoom level of the zoom level range based on the proportion occupied by the remaining object to the plurality of backgrounds exceeding a threshold range.

According to an embodiment, the generating the video may include interpolating at least one intermediate image in the video to increase a frame rate or duration of the video, or excluding, from the video, at least one image with a lowest zoom level or a highest zoom level to decrease a frame rate or a duration of the video.

According to an embodiment, a size of the object may remain constant or varies within a tolerance range of consistency in the video.

According to an embodiment, a background may appear to compress toward the object or expand outward from the object in the video while a size of the object remains constant or varies within a tolerance range of consistency in the video.

In an embodiment of the present disclosure, reasoning prediction is a technique of logically reasoning and predicting by determining information and includes, e.g., knowledge-based reasoning, optimization prediction, preference-based planning, or recommendation.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

What is claimed is:

1. A method comprising:
obtaining a first image of a subject via a first camera;
identifying an object corresponding to the subject from the first image;
obtaining a plurality of second images of the subject with varying zoom levels via a second camera;
identifying a plurality of backgrounds from the plurality of second images;
determining a zoom level range based on the object and the plurality of backgrounds; and
generating a video comprising the object and the plurality of backgrounds with zoom levels varying within the zoom level range.

2. The method of claim 1, wherein the first image is associated with first imaging parameters comprising at least one of an exposure value, an International Organization for Standardization value, a shutter speed, or an aperture, and wherein the obtaining the plurality of second images comprises:
determining second imaging parameters based on a scene of the first image; and
obtaining the plurality of second images of the subject via the second camera using the second imaging parameters.

3. The method of claim 1, wherein the obtaining the plurality of second images comprises:
identifying the second camera from among a plurality of second cameras other than the first camera based on a supported zoom level range of the first camera; and
obtaining the plurality of second images of the subject via the identified second camera.

4. The method of claim 1, wherein the second camera is the first camera.

5. The method of claim 1, wherein the identifying the object comprises:
performing image segmentation on the first image to generate an object map; and
identifying the object indicated by the object map.

6. The method of claim 1, wherein the identifying the object comprises:
identifying a plurality of objects from the first image; and
identifying the object corresponding to the subject by selecting the object from the plurality of objects.

7. The method of claim 1, the identifying the plurality of backgrounds comprises:
identifying the plurality of backgrounds from the first image and the plurality of second images.

8. The method of claim 1, wherein the identifying the plurality of backgrounds comprises:
identifying the plurality of backgrounds, by excluding the object corresponding to the subject from the plurality of second images and reconstructing the plurality of second images in which the object is excluded.

9. The method of claim 1, wherein the determining the zoom level range comprises:
identifying similarity between the plurality of backgrounds; and
identifying a lowest zoom level of the zoom level range or a highest zoom level of the zoom level range, based on the similarity exceeding a threshold.

10. The method of claim 1, wherein the identifying the object comprises:
identifying a plurality of objects from the first image; and
identifying the object by selecting the object from the plurality of objects, and
wherein the determining the zoom level range comprises:
identifying a proportion occupied by a remaining object other than the identified object to the identified object or the plurality of backgrounds; and
identifying a lowest zoom level of the zoom level range or a highest zoom level of the zoom level range, based on the proportion occupied by the remaining object to the identified object or the plurality of backgrounds exceeding a threshold range.

11. The method of claim 1, wherein the generating the video comprises:
interpolating at least one intermediate image in the video to increase a frame rate of the video or duration of the video; or
excluding, from the video, at least one image with a lowest zoom level or a highest zoom level to decrease the frame rate of the video or the duration of the video.

12. The method of claim 1, wherein a size of the object remains constant or varies within a tolerance range of consistency in the video.

13. The method of claim 1, wherein a background compresses toward the object or expands outward from the object in the video while a size of the object remains constant or varies within a tolerance range of consistency in the video.

14. A non-transitory computer readable medium comprising instructions, when executed by one or more processors of an electronic device, that cause the electronic device to perform a method comprising:
obtaining a first image of a subject via a first camera;
identifying an object corresponding to the subject from the first image;
obtaining a plurality of second images of the subject with varying zoom levels via a second camera;
identifying a plurality of backgrounds from the plurality of second images;
determining a zoom level range based on the object and the plurality of backgrounds; and
generating a video comprising the object and the plurality of backgrounds with zoom levels varying within the zoom level range.

15. An electronic device comprising:
memory storing instructions; and
one or more processors comprising processing circuitry,
wherein the instructions, when executed by the one or more processors individually or collectively, cause the electronic device to:
obtain a first image of a subject via a first camera;
identify an object corresponding to the subject from the first image;
obtain a plurality of second images of the subject with varying zoom levels via a second camera;
identify a plurality of backgrounds from the plurality of second images;
determine a zoom level range based on the object and the plurality of backgrounds; and
generate a video comprising the object, and the plurality of backgrounds with zoom levels varying within the zoom level range.

16. The electronic device of claim 15, wherein the first image is associated with first imaging parameters comprising at least one of an exposure value, an International Organization for Standardization value, a shutter speed, or an aperture, and
wherein the instructions, when executed by the one or more processors individually or collectively, further cause the electronic device to:
determine second imaging parameters based a scene of the first image; and
obtain the plurality of second images of the subject via the second camera using on the second imaging parameters.

17. The electronic device of claim 15, wherein the instructions, when executed by the one or more processors individually or collectively, further cause the electronic device to:
identify the plurality of backgrounds by excluding the object corresponding to the subject from the plurality of second images.

18. The electronic device of claim 15, wherein the instructions, when executed by the one or more processors individually or collectively, further cause the electronic device to:
identify similarity between the plurality of backgrounds; and
identify a lowest zoom level of the zoom level range or a highest zoom level of the zoom level range, based on the similarity exceeding a threshold.

19. The electronic device of claim 15, wherein the instructions, when executed by the one or more processors individually or collectively, further cause the electronic device to:
identify a plurality of objects from the first image;
identify the object by selecting the object from the plurality of objects;
identify a proportion occupied by a remaining object other than the identified object to the plurality of backgrounds; and
identify a lowest zoom level of the zoom level range or a highest zoom level of the zoom level range, based on the proportion occupied by the remaining object to the plurality of backgrounds exceeding a threshold range.

20. The electronic device of claim 15, wherein a background compresses toward the object or expands outward from the object in the video while a size of the object remains constant or varies within a tolerance range of consistency in the video.
